(19) United States
(12) Patent Application Publication
(10) Pub. No.: US 2006/0010029 A1
(43) Pub. Date: Jan. 12, 2006

(54) System & method for online advertising

(76) Inventor: John N. Gross, San Francisco, CA (US)

Correspondence Address: J. NICHOLAS GROSS, ATTORNEY, 2030 ADDISON ST., SUITE 610, BERKELEY, CA, 94704, US

(21) Appl. No.: 11/117,928

(22) Filed: Apr. 28, 2005

Related U.S. Application Data
(60) Provisional application No. 60/566,644, filed on Apr. 29, 2004.

(51) Int. Cl. G06Q 30/00

(52) U.S. Cl. 705/10

(57) ABSTRACT

A system and method for determining and identifying clusters/kernels of linkings in communities of online users. The analysis is based at least in part on an entropy analysis, such as by dividing a population into cyber neighborhoods, which can be geographic based and/or logically related.

### RELATED APPLICATION DATA

The present application claims the benefit under 35 U.S.C. 119(e) of the priority date of Provisional Application Ser. No. 60/566,644 filed Apr. 29, 2004, which is hereby incorporated by reference.

### FIELD OF THE INVENTION

The present invention relates to online advertisting, such as identifying and measuring changes in awareness of information, items, etc., within communities, including particularly to identifying a response to advertising presented to Internet based electronic neighborhoods.

### BACKGROUND

The Internet is used extensively now by a growing percentage of the public. At this time, several online websites in fact generate the bulk (if not the entirety) of their revenues from servicing online users and subscribers. These include, for example, companies such as AOL and Yahoo! (content providers), Amazon (books, music, and video recordings), EBay (auctions), Netflix (DVD rentals), Google (search engines) and Doubleclick (advertising) to name a few.

All of these companies monitor the interactions of online users with their websites, and in some cases collect explicit profiling information as well from such users. This is done for the purpose of collecting both individualized and aggregate data, which in turn helps them to better customize the site and overall experience for subscribers, to retain subscribers through personalized interactions, to better target advertising and product recommendations, etc. In some instances the data is logged and later used for data mining purposes, such as for identifying trends (a specific example of this is described in U.S. Pat. No. 6,493,703 which is hereby incorporated by reference) and for giving feedback to recommender systems (i.e. such as with Netflix's Cinematch engine).

A similar concept is illustrated in U.S. Patent Publication no. 2003/0004781 to Mallon et al. in which a community “buzz” index can be used to predict popularity, for example, of a particular movie before it is released. This application is also hereby incorporated by reference. Thus, this disclosure specifically mentions the usefulness of monitoring an overall awareness by an online group of certain concepts (i.e., such as the brand name of a product), in order to gauge the potential economic performance of such product later.

A website maintained by Yahoo!—buzz.yahoo.com—(the full URL is not included because of PTO citation restrictions, but can be determined by placing a browser executable suffix) also similarly monitors and tabulates online user content queries/viewings and identifies the same in a so-called “Buzz” score Index that is updated daily and presented for public viewing. This list, in essence, acts as a form of “popularity” identification for certain topics. For example, the list may identify that stories about a particular singer were the most talked about, queried, or viewed.

The Buzz Index by Yahoo! further includes a “Movers” section, which basically identifies people, stories, etc., which experience the greatest degree of change in buzz score on a day to day basis. Thus, for example, a particular celebrity may be identified in a prominent story, and that would elevate such celebrity's “mover” status, even if the overall buzz score was not sufficient to break into the top buzz score index. For further information, the reader is recommended to such website.

Another related system used by Yahoo! is a marketing tool on another website—solutions.yahoo.com—which permits companies to analyze behavior of online users, and determine particular characteristics which may be useful to such company. For instance, in one case, Yahoo! was able to track online behavior and combine it with traditional demographic and geographic information (to arrive at a subscriber profile) for a company that provided moving services. From this data, they then tried to glean what profiling data was suggestive of a high likelihood of such subscriber moving. In this manner, Yahoo! was able to “mine” the profiles and develop better target advertising for the moving company to a more specific audience. It can be seen that this example can be applied to many other fields.

While the aforementioned Yahoo! systems provide useful information, they fail to yield at least one additional piece of information: namely, which groups or subscribers are “trendsetters.” In other words, while the Yahoo! Buzz Index identifies the existing top popular concepts, and the concepts which are changing the most at any moment in time, it makes no correlation between the two. That is, from looking at the Buzz Index Score for a particular concept, there is no way for a subscriber to know, which persons or group were the first to be associated with such concept. Similarly, the marketing solutions website is useful for predicting which persons are likely to meet a particular criteria, but does not otherwise identify whether such persons are the first adopters of a particular concept—i.e., such as the first to query/view certain content, the first to buy a particular product, or the first to try a particular service.

This additional piece of information is extremely valuable, because it can be used in a variety of ways to improve an e-commerce website as explained in further detail below.

An article by Garber et al. entitled “From Destiny to Destiny: Using Spatial Analysis for Early Prediction of New Product Success” February 2002, incorporated by reference herein (“Garber et al”), describes yet another technique for predicting the success of a product at a very early stage of an introduction cycle. Garber et al. postulate that internal influence from previous adopters, including word-of-mouth and imitation, play a significant role in the success of a innovation (i.e., product, service, concept). They further argue that word-of-mouth spread is naturally associated with geographic proximity of the adopters. Thus, they theorize that, for popular products, geographic “clusters” of adopters are formed, which clusters can be identified at an early date to predict the success, or lack of success of a new innovation. Conversely, Garber et al contend that if there is overall reluctance to adopt the new innovation, word-of-mouth is less, and leads to more sporadic patterns of sales. In such instance, they believe that any adoptions are the result primarily of “external efforts” such as advertising. This, in turn, should lead to a more uniform geographical distribution of adopters.

Notably, Garber et al.'s proposed models for estimating cluster formation are limited to physical, geographical clusterings. They do not provide any insight on how their techniques could be applied in another domain, including for example, to data collected from Internet based shopping or e-commerce. Nor do they describe how relevant geographic data could be reliably collected from online users to perform a cluster formation analysis. Finally, Garber et al. do not explain how such methodology could be extended to other domains, such as in the areas of identifying overall awareness of certain topics, ideas, etc. in an online population.

Conversely, while certain e-commerce operators such as Amazon maintain “top seller lists” for specific groups (based on city, state, domain name, organization, etc.), they do not apparently make any effort to analyze or glean the kind of clustering behavior noted in Garber et al. Accordingly, there is a clear need for a mechanism which could effectuate the type of analysis described in Garber et al in the cyberspace domain.

### SUMMARY OF THE INVENTION

An object of the present invention, therefore, is to overcome the aforementioned limitations of the prior art;

Another object is to provide a system/method for identifying trendsetters, both within and outside an electronic community, including both by statistical analysis and direct explicit interview profiling information;

A related object is to provide a system/method for analyzing the behavior and effects of trendsetters both within and outside an electronic community;

Another object is to provide a system/method for analyzing the behavior and effects of other members within and outside an electronic community, including trend laggards, and trend rejecters;

Still another object is to provide a system/method for testing, rating and reporting on an adoption rate and/or expected demand for a particular item, both within and outside an electronic community;

A further object is to provide an automated system/method for customizing and determining the effects of particular types of advertising on different types of members within an electronic community;

Yet another object is to provide certain types of recommender systems, search engines system, and a content presentation systems, which take into account the adoption behavior of participants using such systems;

Another object is to provide a system/method for calculating and quantifying the existence of trend predictor items within member adoptions, which items are useful as markers for the potential success of other items within a member's list of adopted items.

Still another object is to provide a system/method for measuring a predicted success for an innovation based on data collected from online users, including from cyber neighborhoods;

A related object is to provide a system/method for identifying artificial cross-linkings between web pages (which are sometimes added for biasing a search engine result) so that an index used for search engine queries can provide more relevant and noise-free results;

It will be understood from the Detailed Description that the inventions can be implemented in a multitude of different embodiments. Furthermore, it will be readily appreciated by skilled artisans that such different embodiments will likely include only one or more of the aforementioned objects of the present inventions. Thus, the absence of one or more of such characteristics in any particular embodiment should not be construed as limiting the scope of the present inventions. Furthermore, while the inventions are presented the context of certain exemplary embodiments, it will be apparent to those skilled in the art that the present teachings could be used in any application where it would be desirable and useful to identify the existence and behavior of trendsetters.

### DESCRIPTION OF THE DRAWINGS

FIG. 1 is a flow chart illustrating the steps performed by a trendsetter evaluation and feedback process implemented in accordance with one exemplary embodiment of the present invention;

FIG. 2A is a flow chart illustrating the steps performed by a trendsetter identification process implemented in accordance with one exemplary embodiment of the present invention;

FIG. 2B is a depiction of a portion of a trendsetter evaluation matrix used by a trendsetter identification process implemented in accordance with one exemplary embodiment of the present invention;

FIG. 2C illustrates a table generated by an exemplary calculation procedure associated with the trendsetter evaluation matrix of FIG. 2B;

FIG. 3B illustrates the steps performed by an exemplary embodiment of the present invention to determine early adopters of items;

FIG. 3C illustrates a set of trendsetter ratings tables generated in accordance with one exemplary embodiment of the present invention;

FIG. 3D illustrates part of a procedure for determining an appropriate size for a set of trendsetters;

FIG. 3A is a flow chart illustrating the steps performed by an item popularity/demand prediction engine implemented in accordance with one exemplary embodiment of the present invention;

FIG. 4 is a time chart illustrating a typical adoption rate of a new item within an online community, identifying particular regions where subscribers behave as early adopters, middle adopters and late adopters.

FIG. 5B is a illustrates a correlation/relationship between various items in an online community, such as between certain popular items, and other more obscure items;

FIG. 5A illustrates the basic steps performed by an item trend predictor identification process implemented in accordance with another embodiment of the present invention.

FIG. 6 illustrates a preferred embodiment of a trendsetter identification system 600 constructed in accordance with the present invention.

FIG. 7 illustrates a preferred embodiment of an innovation prediction process 700 implemented in accordance with the present invention.

### DETAILED DESCRIPTION

The present invention is generally directed, as noted above, to the identification of persons (or even other non living entities whose behavior can be studied) that behave or can be characterized as “trendsetters.” In this respect, the term “trendsetter” as used herein is intended generally to mean those persons who have behavioral tendencies, affinities, or opinions about items which tend to be ahead of their peers—at least from a time perspective.

Thus, trendsetters are generally persons whose behavior, beliefs, tastes, actions, etc., are imitated and copied by other persons, and/or are simply slightly ahead of the curve so to speak against other persons. They act as indicators of the paths that others will take. In some instances persons will be considered trendsetters by virtue of their status within a community, such as the special status afforded to celebrities. These persons will naturally serve as trendsetters because their behavior, beliefs, biases, taste, actions, etc., are widely publicized for consumption, and are thus widely imitated by other person.

In other situations, however, persons may behave as trendsetters without knowing the role they are fulfilling, and simply because they have a form of cultural antenna in tune with the zeitgeist. For example, early adopters of a particular new type of computer can be seen to be a form of trendsetter. Persons who are the first to look for, read and/or spot particular new content (i.e., news stories) can also be trendsetters. Many more examples will be apparent to those skilled in the art, and as used herein the term is intended to be interpreted in its broadest sense consistent with this disclosure.

Accordingly, in a preferred embodiment describe below, the behavior that is being monitored is the adoption of a particular item by a person, group or entity in a time fashion that precedes and anticipates the later actions by peers. Nonetheless it will be understood that other aspects of a trendsetter's behavior, beliefs, biases actions, etc., could also be imitated, copied and studied. For instance, it could extend to the bidding behavior of an online auction participant, or the particular interface personalizations selected by some subscribers for their interactions with a website, or the nature of the queries they present to a search engine at an online website.

In other cases, for example, the non-action, rejection or non-adoption of an item by a trendsetter may serve as a basis for imitation and study for identifying trendsetters, such as in the case where a person consistently rejects a particular item in a head to head comparison against other items. The present invention, therefore, can also be used to calculate rejection prevalence or a rejection rate of an item by a group of trendsetters.

As can be seen from the present disclosure the present invention is primarily concerned with “useful” trendsetters, meaning those persons whose adoptions end up becoming sufficiently popular or imitated within a large enough community. The degree of popularity, and the size of the community can be extremely variable of course, but the point is to exclude “early” adopters who have impulsive, indiscriminate behaviors (i.e., buy anything new). Such persons do not communicate useful information in the sense that their behavior is not sufficiently predictive of a future trend.

Conversely, persons whose behavior tend to behind the general population, or can be considered as late adopters of an item, can be generally described as “trend laggards.” As explained below, identifying and monitoring trend laggards can also be useful in some contexts. Thus when the term “trendsetter” is used below, it will be understood that it could also refer to a trend laggard as well, except where it is apparent to one skilled in the art from the context that such is not logical and/or consistent with the present description.

Further as used herein, the term “item” is also intended in its broadest sense, and my refer, for example, to a product (books, auction articles, music recordings, and the like) a service, a human readable content piece (an online news story, video, comment, a web page, a website, an interface customization, etc. The item could even refer to a more abstract concept, such as a person, a security, an opinion, a belief, etc. Basically, the term can refer to anything which can be accurately measured in connection with a group of individuals or entities, including persons within an online community, websites associated with particular subject matter, etc.

It should be noted that the trendsetters identified by the present invention may or not be drawn from the community under consideration. In other words, it is entirely possible that the existence and behavior of trendsetters within one community can be used as a useful gauge for determining the expected demand for an item in an unrelated community. For example, the consumption of ads by a particular set of persons within a particular electronic community might be a sufficiently useful proxy for predicting the behavior of a different set of persons expected to view such ads in a different medium (i.e., television.) The predictions of a stock price by one or more trendsetters may be used to anticipate the performance of a stock within a trading market.

Furthermore, as used herein, a trendsetter could refer to a single person, or to a group of persons having some common characteristic, such as membership in a group, or a particular demographic profile. Trendsetters can also be broken out and characterized by sub-group, and demographic group as may be desired or convenient. For instance, trendsetters may be further classified according to sex, age, or income. In another application, they may be classified according to subgroup.

Thus, even within a single community, one group may have one set of trendsetters for a group of items, while in another group a different set of trendsetters may be identified for such items. This allows for finer differentiation at a level that is more personal. An example of this are the subgroups and communities created by Amazon from its customer base, such as groups of customers from a particular domain, customers from a particular zip code, phone area code, etc. Other examples will be apparent to those skilled in the art.

In some instances, a non-human entity could be used as well, if such entity's behavior can be meaningfully compared against other entities. As an example, the invention could be used to determine which companies are leaders in using certain types of terminology in press releases, product descriptions, etc. Even web pages or websites can be examined for trendsetter status in some cases.

Finally, even items themselves can be characterized as forms of trendsetters for reasons set out further below, if they provide useful statistical predictive value on other items. Other examples will be apparent to those skilled in the art, and thus it should be appreciated that the invention is not limited in this respect.

Finally, while trendsetters in the preferred embodiment are identified by way of their adoptions of items, this is not the only mechanism that can be used. For example, a trendsetter may be determined with reference to other indicia, such as implicit and explicit inputs. In other words, it is not only adoptions that may signify a trend setter.

The reasons why trendsetters are important are many, and include generally the following:
(1) Members of an online community generally like to be identified and appreciated for their contributions. The invention provides a positive label for their activities and increases the likelihood that they will share personal information that can be used by a website operator;
(2) Other members of the online community like to be kept informed of new trends (i.e., trendy items) and who is associated with such trends;
(3) Larger collections of members (i.e. such as message boards devoted to a topic, online groups associated with particular topics, etc.) can also be analyzed and classified as trend setters within a larger subscriber population. For example, a number of Yahoo! Message Boards, and/or Yahoo! groups could be studied to determine which of such boards or groups is a trendsetter on a particular topic. These boards and groups can then be identified online for the benefit of other members, so that they can determine where to go for learning new trends.
(4) Members of the online community can voluntarily “subscribe” to a trendsetter (person or group), and thus gain the benefit of the latter's early prescience concerning the popularity of items;
(5) By measuring the acceptance or adoption prevalence, or adoption rate of an item by a set of trendsetters, a supplier of the items can better gauge expected demand or potential for the item;
(6) The degree of adoption by trendsetters can be measured and used to influence a recommender system. It is well known, for example, that collaborative filtering systems suffer from “first rater” problems, and thus the present invention can be used to influence and bias a recommender system by disproportionately weighting the selections of certain individuals at an early stage to accelerate the learning of the CF system;
(7) The profiles, demographics, etc. of trendsetters can be gleaned by outside entities and used for advertising/marketing purposes, in the same manner as used by the aforementioned Yahoo! solutions program;
(8) Since trendsetters are some of the most valuable assets of an online community, identifying them early allows a website operator to provide them with inducements and rewards to stay within the online community;
(9) Product marketing/sales statistics can be determined from studying the trendsetters, including an overall trendsetter adoption percentage, adoption prevalence, adoption rate, as well as benchmark comparisons to prior popular items;
(10) Trendsetters can also be used for influencing the score of a search engine. It is well-known that some search engines use a form of relevance scoring in presenting search results. By weighting items associated with trendsetters (which can be items adopted by persons, or individual sites that are rated as trendsetters among other websites) more highly, this can further serve to improve the performance of such systems.
(11) Other preferences of trendsetters can be explored and presented for public viewing, such as personalization features and functions they may use at content provider sites, including content categories they review, websites they visit, and interface customizations that they use.

These are but a few reasons why identifying trendsetters are an extremely useful process, and others within the scope of the present invention will become apparent to those skilled in the art from the present disclosure.

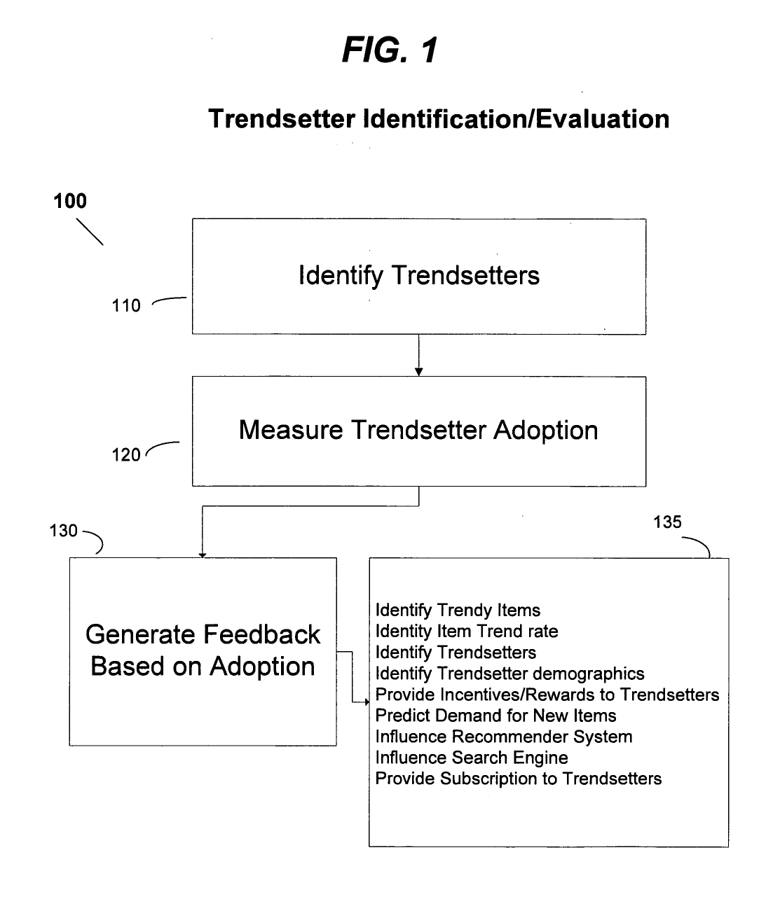

FIG. 1 is a flow chart illustrating the steps performed by a trendsetter evaluation and feedback process 100 implemented in accordance with one exemplary embodiment of the present invention. As described herein, such process (as well as the other processes explained below) can be embodied and expressed in a variety of software programs, routines, etc., that run on one more client or server devices coupled to the Internet, using techniques that are well known in the art. The types of systems which can embody the present inventions can include a variety of conventional hardware platforms known in the art, including data processing equipment and computers with a wide range of computing/storage resources and capabilities. Accordingly, the details of such software and hardware implementations are not material except as discussed herein with reference to specific aspects of the invention, and they will vary significantly from application to application based on a desired performance.

As noted in FIG. 1, a first step 110 is to identify the trendsetters, which, as noted above, preferably will be from within a particular online community, but need not be. For example, an online community might consist of all subscribers to Amazon, EBay, Netflix, etc., or those users who frequent Yahoo!, Google, etc. Alternatively, the trendsetters could be determined by reference to a sub-group, if the overall online community population is not easily manageable, and/or to make the trendsetter identifications more relevant to particular categories of users. A preferred process of identifying the trendsetters is explained in more detail below, using a variety of electronic data collection techniques.

At step 120 the adoption prevalence (and/or adoption rate) for one or more items is measured for the trendsetters. Generally speaking, these particular items represent newly introduced items to the online community, so that they are not already adopted by a large percentage of the online community members. Again, a preferred process of identifying the adoption prevalence (and/or rate) is also explained in more detail below.

During step 130, after determining the adoption prevalence, a variety of different reports, feedbacks, responses, etc., can be generated based on a value of the measured adoption prevalence. This includes, for example, the options identified at 135, and which were alluded to earlier.

For instance, a website operator could generate a list of “trendy” items based on an identification of new items which have achieved a particular adoption prevalence (or adoption rate) by the trendsetters. The trendsetters themselves could also be identified, typically by their online handles. The aforementioned options include, of course, publishing such data for online consumption by other members of the community, in a manner similar to that done by buzz.yahoo.com. The percentage of trendsetters who adopt over time, as well as comparisons to adoption rates for other items could also be published.

Similarly, a website operator could use the trendsetter data to provide specialized custom reports for particular entities who may wish to see the acceptance rate of a particular new product/service. The entity may be a music publisher, for example, who desires to know the acceptance rate of a particular title. In such case, the music publisher may be able to generate an expected demand prediction for the item by the remainder of the online community, well in advance of the actual demand. This can assist in accurate and efficient planning for product advertising, manufacturing, shipping, administration, etc.

Alternatively, the invention could be used in a manner similar to that described by Mallon et al., except that the “buzz” measurement could be made only of the identified trendsetters, instead of the random categories envisioned by the Mallon et al. disclosure. Thus, the predicted demand for movies, music, and other entertainment could be predicted by reference to a more reliable data set. Advertisers can also use the present invention to measure the effects of advertising on particular groups, particularly trendsetters.

The website operator could also provide a mechanism for the other online community members to “subscribe” to particular trendsetters, much in the same way as that done at the launch.yahoo.com website. The latter website allows an individual user to be “influenced” by other members, so that the tastes of such members are imposed in the form of musical selections for the user. The limitation of this site, however, is that it does not identify those members who may be trendsetters, so subscribers are not able to glean the status of another member merely by looking at the data for such member. Moreover the Launch site allows a person to be “influenced” by an entire community, as set out in World Application serial no. 02/05140 to Boulter et al (U.S. Ser. No. 09/79,234) incorporated by reference herein. These are useful features, but they do not allow for specific tailoring of musical tastes. Using the present invention, however, an online member can elect to be “influenced” or kept informed of a particular trendsetter's (or a group of trendsetters) selection of items (be they music, products, services, or something else). This feature has the advantage as well of allowing an e-commerce site to achieve more rapid and effective penetration of new items to a community, and before its members potentially hear of such articles at a different site. Again, from the perspective of an e-commerce vendor, it is preferable if they are the first to present new items to persons who frequent their sites, because they run the risk of losing a subscriber or even a potential sale if such person learns of a new item elsewhere.

A similar benefit can be used in connection with a recommender system. Again, recommender systems are well-known and commonly used at e-commerce sites. These systems are known, also, however, to suffer from so-called “first-rater” problems, and this leads to the problem that they do not react very quickly to the introduction of new items or to changes in attitudes by their users. By exploiting the early scouting intelligence provided by trendsetters, e-commerce entities can essentially “tune” their recommender systems (typically based on a collaborative filtering algorithm) very early to substantially reduce this type of problem. In other words, an e-commerce recommender system can be programmed in one implementation to weight the adoptions of trendsetters more heavily than other users, and thus essentially accelerate the learning process for new products. In a collaborative filtering system, the trendsetters could be artificially multiplied and “planted” into different user clusters to influence the recommender system behavior. For an example of the use of “clustering” in collaborative filtering mechanisms in which the present invention could be used, see the recent article by Wee Sun Lee entitled “Collaborative Learning for Recommender Systems” appearing in the Proc. 18th International Conf. on Machine Learning (2001) and which is also incorporated by reference herein.

Other techniques for incorporating the teachings and behavior of trendsetters, and mechanisms for influencing the operation of a recommender system will be apparent to those skilled in the art.

Other useful information can also be gleaned from the trendsetter data, including their respective profiles, demographics, other related tastes and dislikes, etc. This information is extremely valuable from an advertising and marketing perspective, since many entities would like to interact and solicit feedback from such types of individuals. If an e-commerce site can effectively identify such individuals, this database can be marketed as a valuable commodity to other entities.

For similar reasons, since trendsetters are valuable assets for an online community, identifying them early allows a website operator to provide them with inducements and rewards to stay within the online community. Furthermore, the present invention can be used to “mine” other online communities for the purpose of locating, verifying and contacting other potential trendsetters for particular items, or categories of items. For example, one or more websites may agree to allow limited inspection of their respective subscriber databases to other websites for the purpose of exchanging useful marketing information. This function, again, can be valuable for increasing the stickiness and appeal of a particular website.

Identifying Trendsetters

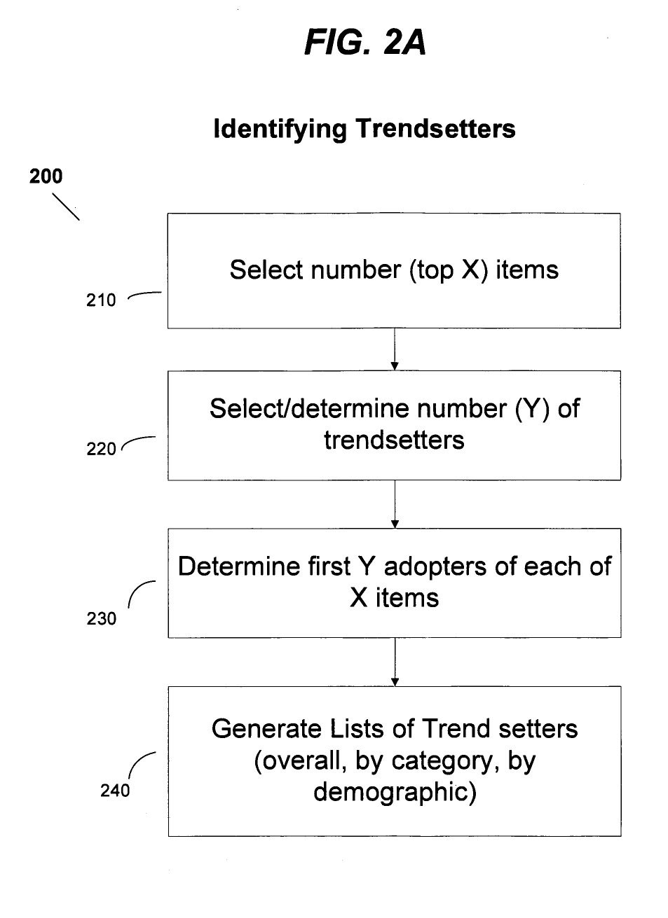

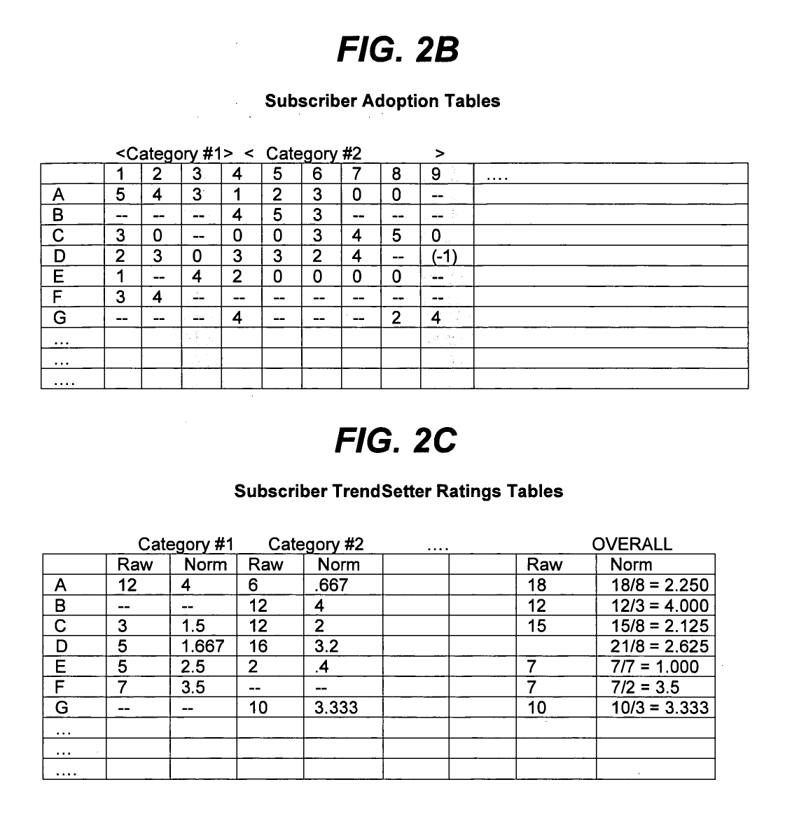

FIG. 2A is a flow chart illustrating the steps performed by a trendsetter identification process implemented in accordance with one exemplary embodiment of the present invention. As seen there, a first step 210 examines which items are the most popular within the community at a given time, which may be the present, or some prior date. It should be apparent that the process can be executed to identify trendsetters for a single items, multiple items, or items within a larger logical grouping, such as a category or sub-category of items. For example, an item might be a particular title of a book; a category of books might be logically grouped by artist, genre, publisher, etc.

It should be clear that “popularity” of an item (or items) could be measured by reference to numbers of units sold, a number of units rented, a number of page views, a number of queries, a number of messages, etc., and the degree by which an item is deemed to be popular can be measure in any number of ways, including, for example, a percentage. Thus, in the present example, an item is deemed “popular” when it is among the top 10, or among the top 10% of items. Other applications are likely to use other benchmarks for determining popularity.

In any event, after identifying the set of popular items, the process then calculates a number Y of persons at step 220 that it is going to use and characterize as “early” adopters, or trendsetters. This value, of course, could be changed on an item by item, or category by category basis as needed. The trendsetter number could be generated as a constant (i.e., the first 100 people), or as a percentage of the total who have adopted the item. Furthermore, trendsetters could be characterized on a graduated scale. In the latter case, for example, the first 100 adopters may be given one weight, the second 100 adopters a lower weight, etc., so that multiple levels of trendsetters could be established for an item.

In another instance the value of Y can be gleaned by statistical analysis/prediction. In other words, by studying an adoption prevalence (or adoption rate) for popular items, one skilled in the art can determine experimentally, using varying confidence levels, what the smallest value of Y is required to serve a useful prediction value. This calculation has utility because it is preferable, of course, to reduce the universe of trendsetters to its minimal but still useful value. In some cases the invention can calculate both types of values for the trendsetters: i.e., one calculation for identifying the number Y of trendsetters, and another value Y′ for identifying the smallest number of trendsetters that can yield useful predictive information.

Again the specific calculations will vary from application to application, and will be unique to each environment and to the particular needs/interests of an e-commerce site.

At step 230, the process then identifies the actual trendsetters by examining the first Y adoption times of each item in the set of popular items. Again the trendsetters are preferably identified from within an electronic community using a conventional electronic data collection technique, but do not have to be. This is because in some cases, for example, the nature of people's behavior may be such that a first group's individual and collective behavior can be more accurately modeled, tracked, and used for predictive value for a second unrelated group. The latter, for example, may not provide sufficient tracking information that can be meaningfully analyzed.

Finally, at step 240 the trendsetters are explicitly listed by item, by a group of items, or in aggregate across an entire sampling population. These lists can be used as noted below for private use in marketing, planning, and/or they can be published electronically online as well for community consumption. In the latter case a particular community can see who the trendsetters are for a particular item, or who the trendsetters are for a category of items, or who are the overall trendsetters across all items.

A preferred process for identifying trendsetters is depicted in FIG. 2B with reference to a first trendsetter matrix which corresponds generally to a database of records identifying, in the far left hand column, a particular person, and in the adjacent columns the identity of particular items that are available in the database. Each intersection of row and column identifies whether such person adopted (i.e., looked at, purchase, rented, queried, talked about during an electronic data collection session) such item, and, if so, what score they achieved vis-à-vis a trendsetter rating. For example, for person A, he/she has achieved a trendsetter score of 5 for item #1, a score of 4 for item #2, etc. The items are further logically grouped into categories as noted, so that items #1-#3 belong in a first category, while item #4-#9 are in a second category.

The trendsetter matrix is compiled from ongoing loggings of user selections of items, and because of its nature does not have to be performed in real-time. In fact, it may be calculated daily, weekly, or even on a periodic basis for a target set of items as requested by a particular third party to generate customized reports. An example of the usage of such types of matrices, in a related context of examining user ratings of items for a collaborative filtering algorithm, is discussed in an article by Melville et al. entitled “Content Boosted Collaborative Filtering” from the Proceedings of the SIGIR-2001 Workshop on Recommender Systems (New Orleans, La. September 2001) and which is incorporated by reference herein.

In one embodiment the correlation matrix can include all of the items in an item database, so that as new items are added, some additional predictions can be made about them as explained below. In situations where additional demand type predictions ate not needed or desired, the correlation matrix may be composed only of “popular” items as determined from the above.

It is understood of course, that this depiction is a simplification of only of a small section of a person-product correlation matrix which is intended to help in comprehending the present invention. In any actual commercial application, the form of the matrix, the type of data and the size of the same could be significantly different. Nonetheless, even from this simplified depiction, one skilled in the art can appreciate how one or more trendsetters can be identified from the aforementioned matrix.

Accordingly, in FIG. 2C, a table of trendsetter scores is compiled from the trendsetter matrix. The trendsetter scores can be derived for individual items, groups (categories) of items, or even for the entire item set.

Thus, for example, for item #1, Persons A, C and F could be classified as trendsetters, if a threshold value of 3 is specified for the trendsetter score. Again, the rating required to be identified as a trendsetter could vary from community to community, and it is not necessary to use a scale of 1-5; any scale, in fact, which allows for ranking is entirely suitable.

The trendsetter scores are first tallied across all items within a category, and then normalized by the number of items adopted by the person within the category. Some scores and ratings may be adjusted statistically for the following reasons.

First, if desired, users who have adopted over a certain threshold percentage of items may be eliminated statistically to avoid biasing the results. That is, some persons may be simply indiscriminate (albeit also early) adopters, and thus users of the invention might track and eliminate such types of users. Again, the invention can be used to identify users who simply purchase a lot of items as random consumers of everything, not trendsetters per se; the choice of course, can be determined on a community by community basis.

Similarly, persons who have not adopted a sufficient number of items within a category may also be eliminated, to avoid attributing trendsetter status to persons with insufficient track records. Thus, the invention can be used to glean the user's overall behavior and trendsetter rating within a category of items, by examining their behavior over a large enough sample set to reduce random errors.

In accordance with this above, therefore, it can be seen that within category 1, users A and F can be classified as trendsetters using one set of criteria. Persons C and E simply have an overall score that is too low, even as they have adopted a sufficient number of items (2) in this instance. A dash (-) is used to denote that the person has not adopted such item. Even though user D has a reasonably high raw score (5) within category 1, he/she is not characterized as a trendsetter, because their normalized score is (5/3)—i.e., their raw score/#items rated. Thus, D's purchase of item #3, in which they scored no points, is indicative of their late tendency in some cases, so they are not rated overall high enough to merit trendsetter status. In this manner, the invention further rewards accuracy in the behavior of users in discriminating their item adoptions. Person G has not adopted a sufficient enough number of items to be rated fairly, so they do not qualify in this instance for trendsetter status.

Similarly, in the Category 2 items, persons B, D and G now qualify as trendsetters, based on the same kind of scoring logic as noted above. From the above it can be seen that persons who are trendsetters over one set of items (i.e. person A is a trendsetter in Category 1) may not be trendsetters with respect to a different set of items (i.e., Category 1).

An overall score can also be calculated, as shown in the right hand columns of FIG. 2C. In this instance, users B, F and G are excluded because they have not sampled (or adopted) a sufficient number of items. The highest three scores belong to D, C and A respectively, so they may be identified as overall trend leaders. It can be seen, therefore, that even though C is not a trendsetter at either category level, he/she could still be eligible for overall trendsetter status based on their total aggregate behavior.

Again, the thresholds for scores and items ratings can be varied from the above, and are expected to be adjusted differently from case to case within the scope of the present invention. If desired, different ratings criteria could be used to identify a trendsetter at the item level as opposed to the category level or aggregate level. For example, at the aggregate level, a score greater than 2 may only be required to achieve a trendsetter status. By mining and exploring the data set in this fashion, a large number of interesting and useful trendsetter parameters can be gleaned for a particular population sample.

Trendsetter Analysis to Determine Trend Predictors

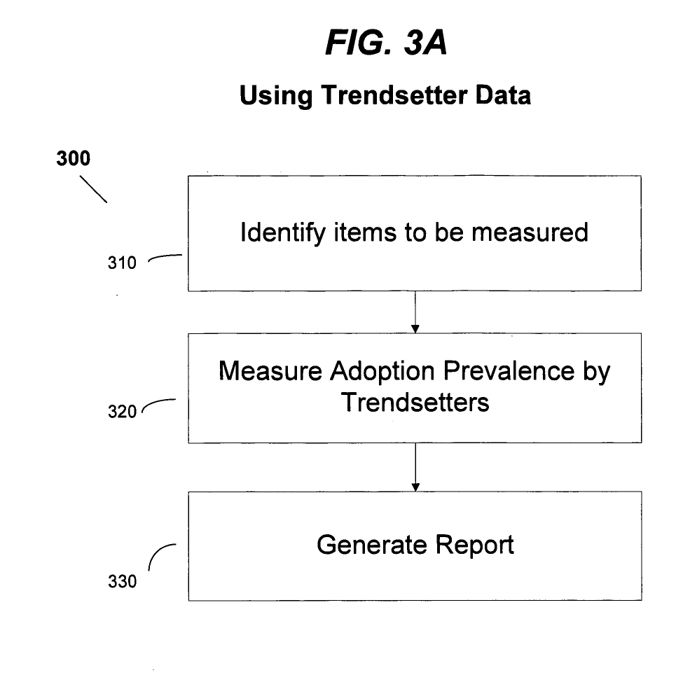

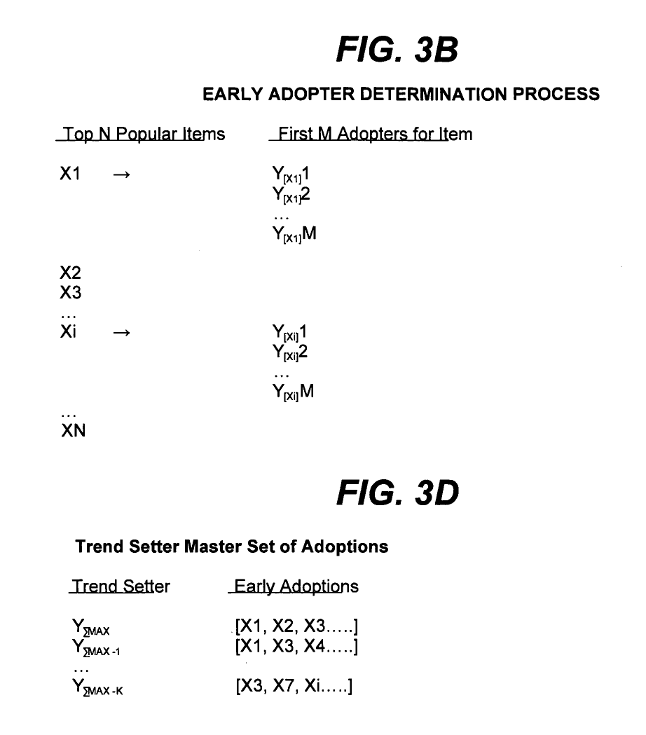

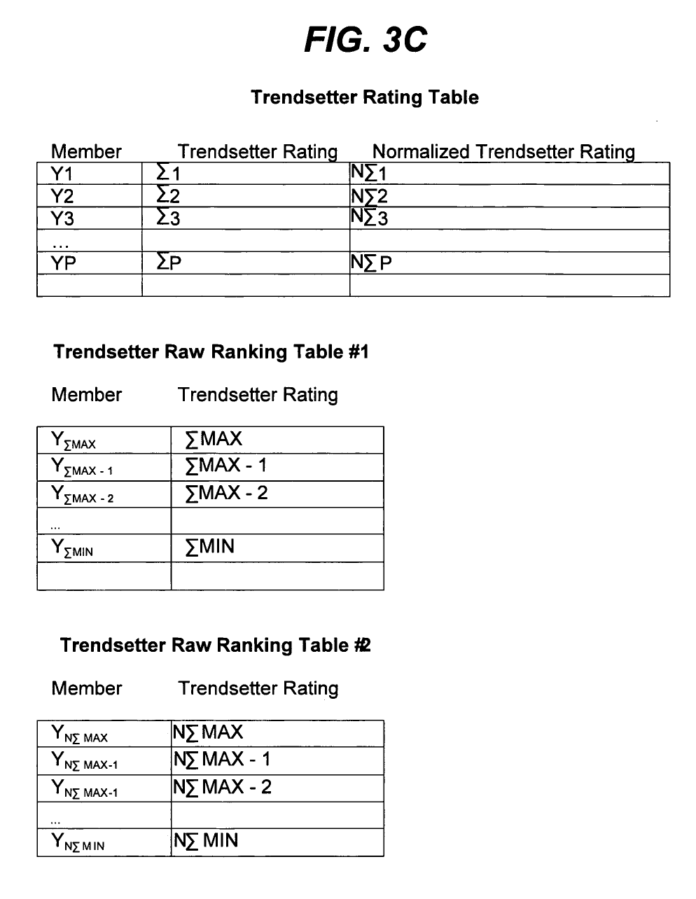

Another useful tool for identifying and classifying trendsetters in aggregate across a community is illustrated in FIGS. 3A to 3D. This second embodiment of a trendsetter identification process can be used alone and/or in conjunction with the process described above for the reasons set forth below.

As seen in FIG. 3B, for each popular item (Xi) in the set of N popular items (X1, X2 . . . Xi . . . XN) a determination is made of the first M adopters (Y[xi]1 to Y[xi]M). Again, the choice of N and M are somewhat arbitrary, and are expected to vary from application to application.

A first trendsetter listing table is then created as shown in FIG. 3C. Each item Xi is processed until a table is derived of the entire set of adopters (Y1 to Yp identified in a first column) who qualified as a trendsetter for one more items, along with their aggregate trendsetter scores (in the second column). Since a particular user may be an early adopter of more than one item, his/her score is increased within the list for every such instance. Thus, for example, if a person Y[x1,1] is an early adopter (meaning anywhere within the top M persons) of ten items of the top N items, then they would have an overall trendsetter prediction rating (Σ) of 10 in the second column of the table of FIG. 3C.

The trendsetter ratings can also be normalized, again, with reference to the total items adopted by the trendsetter under consideration. Thus, as shown in FIG. 3C, the third column in the trendsetter listing table indicates a calculation to denote a normalized trendsetter score (NΣ).

As an alternative the raw trendsetter scores for a particular item could be scaled in accordance with the degree of “earliness,” so that a person could receive a score that is not simply a constant. For instance, if M is 500, a person may receive a score of 10 for being in the top 100 adopters, and a score of only 5 for being between the top 100 and top 500. The person may in fact receive a score equal to his/her actual adoption number within the population. Similar examples will be apparent to those skilled in the art.

Again, as noted earlier, early adopters who have rated too many items, or an insufficient number of items, may be excluded if desired from the tabulation process to arrive at the trendsetter listing table.

In any event, as further shown in FIG. 3C, the set of aggregate trendsetter ratings are then processed from the listing table to generate two ordered trendsetter ranking tables, one by raw score, and one by normalized score. Therefore, as seen in FIG. 3C, Trendsetter Ranking Table #1 is ordered in accordance with those persons who have achieved a highest overall trendsetter score. Conversely, Trendsetter Ranking Table #2 is ordered in accordance with those persons who have achieved a highest overall normalized trendsetter score.

These two sets of aggregate rankings can be used for a variety of purposes. As a first example, it may be extremely valuable, from a marketing, planning, sales and/or advertising perspective to know which and how many members of a group act as benchmarks and early barometers of popular items. By understanding such groups, an e-commerce entity can begin to make predictions about items that have not yet achieved, but which may eventually achieve great success (prevalence) within a particular online community.

A useful benchmark that can be derived for any community is determining the various confidence levels to predict that an item is likely to achieve great success, based on the number of trendsetters who have actually adopted an item. In other words, another calculation that can be performed in the present invention is a determination of how many of the top trendsetters are needed in order to make predictions about the expected popularity of an item, and correspondingly, how accurate such prediction is likely to be.

The determination of the number of top trendsetters that are needed to generate useful predictions (i.e., so called trend predictors) can be determined experimentally using known techniques.

One basic approach would be to simply take the top K trendsetters using a cutoff that is based on a balance of expediency, accuracy, and performance. The top K trendsetters are then used as proxies and benchmarks below for gleaning the expected behavior of an item, or a group of items, which are not yet popular, but which have been selected by some sub sample of such top K trendsetters.

Another approach for determining K is shown in FIG. 3D, where the actual adoptions of items X1 to XN are listed for the K highest ranking members taken from one of the trendsetter ranking tables. K may be determined, therefore, by examining how many members must be listed before all of items in the set (X1 . . . XN) appear in at least one or more of the individual trendsetter adoptions. Alternatively, K may be selected by examining how many members must be listed before the top 10 (or 20 or 50, etc.) items appear in each of the individual trendsetter adoptions. This latter approach helps to create a very focused and precise set of trends predictors. Yet another approach would be to vary K statistically by examining what benefits (i.e., such as reduction in error—or improvement in prediction) are provided through the incremental addition of another trendsetter as a trend predictor.

Trend Prediction

Nonetheless, the invention is not limited in this respect to any particular selection scheme, and regardless of how K is calculated, preferably a sub sample of the trendsetters are then identified in some form as trend predictors. Again, the trend predictors might be taken from one or both of the Trendsetter Ranking tables in FIG. 3B (normalized or unnormalized), and the final choice may be determined experimentally by examining which subsets tend to give the best results. The trend predictors in the population are then used for generating various forms of reports and predictions for marketing/sales/trend analysis in the following manner.

For instance, a supplier of an item may wish to know what the anticipated adoptions (sales, rentals, views) will be for an item within the online community for planning purposes. By measuring the adoption prevalence of the product among the trendsetters, and more particularly, by the trend predictors, the supplier can determine the likelihood of success of such item, based on the fact that such proxies tend to adopt items very early that later turn out to be very popular. The measurement and prediction for a first item might also be used to trigger introduction of a second related item, if the adoption prevalence appears sufficiently large so as to suggest that the two items will be popular within a particular online community.

The adoption prevalence for an item can be measured in a number of ways. For example, the raw number of instances which such item has been adopted by the trend predictors could be measured. Alternatively, a percentage figure could be determined, as well, to indicate a relative percentage of trend predictors (or trendsetters) who have adopted the item.

For example, in the case of the person-item matrix of FIG. 2B, if item #3 and #9 are new items, their adoption prevalence by the trendsetters can be calculated as follows: for item #3, the adoption prevalence is 50% (since only A has adopted the item, and F has not) while for item #9, the adoption prevalence is 33% (since only D has adopted the item, and B and G have not). This is of course, a simplification, and those skilled in the art will appreciate that actual data sets will be significantly larger, and that other mechanisms could be used to compute such adoption prevalences.

In another variation of the invention, a rejection of an item, to the extent it can be accurately determined, can also be specified as part of the person-item matrix, in the form of a negative number, and in varying degrees. For example, if a user is shown an ad for a particular item, and does not respond positively to such ad in any fashion (i.e., through queries, content viewings, etc.) then the item could be given a negative rating, signifying that it was rejected by that user. If the ad or other offer for the item is rejected again in the future, the negative rating could be increased, up to a maximum limit signifying a (perceived) unconditional rejection.

The benefit of collecting data on rejected items, of course, is that the attitude and behavior of the trendsetters and/or trend predictors towards such items can also serve as valuable marketing and prediction information. The negative ratings, of course, would be ignored during calculations of the trendsetters and trend predictors. Nonetheless, it can be seen quite clearly that the trendsetters can help identify early on both products that are likely to be popular, as well as items that are not likely to be popular.

The adoption prevalence could also be studied over time, to glean other useful trend predictive data, such as an adoption rate. Thus, the trend predictor penetration rate could be examined on a day to day, week to week or other specified time basis to see changes in such rate over time. Again, comparisons could be made to historical data as well for better analyzing the behavior of popular items, and predicting the behavior of a new item. An e-commerce vendor may determine, for example, that only certain rates of adoption by the trend predictors exceeding a threshold are meaningful predictors of the popularity of an item.

For example, in a very simple use of the trend predictors, they can be compiled into a list, and identified to advertisers/market researchers. These entities, in turn, can then target their advertising, surveys, etc. to such trend predictors very accurately to glean valuable insights that would otherwise remain buried on a mountain of aggregate data. For instance, as noted earlier, an identification of the topics and interests of the trend predictors (and/or trendsetters) could be measured using techniques such as described in Mallon et al.

The trend predictors in some instances can serve as facilitators for introducing new popular material into a community, because they tend to lead the remainder of the community. By presenting such new items directly to the trend predictors, the likelihood of success of such item also concomitantly increases.

Finally, in some cases it may be desirable to study the other adoptions of items made by a group of trendsetters (or trend predictors), to see to what extent they also share certain item selection adoptions that are substantially different from the overall population being studied. For example, certain obscure content titles (books, movies, articles) may be viewed with significantly greater frequency by trendsetters as compared to other members of the community. These additional items (or groups of items) can serve as additional forms of fingerprinting and identifying trendsetters and trend predictors in the future at an early stage, even when information may be incomplete for a particular individual.

The overall process 300 for generating item adoption rates and predictions is depicted generally in FIG. 3A. As noted there, a list of new items or items specific to a particular supplier are used at step 310. The adoption prevalence within the trend predictors (or the trendsetters as may be desired) is then measured at step 320. At the end, a report can be made at step 330, to identify trend data for the items. Again, a vendor or other supplier of an item can thus measure, at any moment in time, the behavior and performance of a particular item within a very specific but important segment of the population of the online community.

The benefit of the present invention is also evident as it allows for rapid identification of trendsetters and trend predictors, even from relatively new additions to the community of members. That is, unlike traditional recommender systems which require extensive amounts of data collection, the behavior and classification of a member as a trendsetter can occur fairly early and quickly based on an adjustable number of item adoptions. This makes it possible for new ideas and tastes to be more rapidly integrated and disseminated within a particular community, enriching the experience of other members as well. Furthermore, the present invention helps to minimize the effects of “popularity bias,” which is known to cause recommender systems to frequently recommend only items which are already popular throughout the entire community. This is because, as can be seen herein, the influence of certain persons, such as trendsetters, can be weighed at an early stage of an item's adoption to improve its visibility to other members.

In some instances, for example, a content service provider may simply use the trendsetters or trend predictors for providing recommendations for items, in lieu or as a supplement to a traditional recommender system. A “content service provider” (or service provider) in this instance refers generally to an entity that is not directly involved in the creation of new content, but, rather, merely distributes it in some fashion as a service to subscribers.

As alluded to earlier above, in some cases an e-commerce website operator serving an online community may benefit from identifying trendsetters, trend predictors and trend predictions from off-line communities, or even other online communities. This type of process can be automated, as well, as set forth in U.S. Pat. No. 6,571,234 (incorporated by reference herein) based on operator selections to rapidly and automatically inject new materials for consumption by an online community.

Furthermore, as noted above, it is possible to examine and identify smaller “group” or community trendsetters within larger online subscriber lists managed by such entities as Yahoo!, Amazon, EBay, AOL, MSFT, etc., In other words, a content service provider may want to alert and publish lists of particular groups that are trendsetters on particular topics. Thus, for example, an e-commerce entity such as Yahoo! could use the present invention to analyze which message boards or groups were the first to discuss certain types of products, brands, services, etc. These trendsetter groups can be identified, again, for general interest or marketing purposes, on a topic by topic, group by group basis.

In some instances it may be desirable for a first website operator to induce trendsetters, trend predictors, etc., to join a particular community. This can be done by free subscriptions, free services, free products, financial awards, or other similar incentives. By identifying such persons in other online communities and successfully persuading them to contribute to a particular community (even if only indirectly, such as through a recommender system) a website operator can thus boost and improve the overall attractiveness of an online community site.

For other applications it may be possible to imitate the behavior of trendsetters and trend predictors who exist in another online domain. For example, an online community might create a set of proxies who mimic the behavior of another group of persons, in order to obtain the benefit of the input of the latter. The profiles of the proxies could be synchronized on a regular basis to make certain that they reflect current trends.

Moreover, in some cases, it may be desirable to see how an actual trendsetter (and/or trend predictor) from within the community (or even a proxy trendsetter based on a trendsetter from another online community) is treated by various online content providers, again, for the purpose of collecting marketing intelligence. Thus, a first online e-commerce site may create a proxy that imitates a trendsetter from another online community, and then test their own site (i.e., through journaling page views presented to the proxy account, tabulating recommendations made by a recommender system, etc.) with such proxy to see how their site (or other sites) presents itself to such proxy. This technique can be used, for example, to determine if advertising is reaching the appropriate audience.

In another variation of the invention, the trend predictors could be selectors for a particular stock or publicly traded equity. Thus, in a stock picking community, the invention could be used to identify overall successful “early” adopters of successful buy and hold equities for the benefit of other members. For example, some persons may demonstrate that they have a higher degree of prescience in selecting stocks just before they rise substantially (or even decline substantially) in price. When such trend predictors select new stocks in sufficient numbers (i.e., as measured by a prevalence rate) this data could be communicated to the other members to alert them to the newest potential hot pick.

In still another variation of the invention, the trend predictors could be used by an online search engine, such as the type of system used and operated by Google. The latter uses a form of weighting when presenting webpage results to queries, based on a number of links to such webpages. In many respects, the lack of links can be analogized to a lack of ratings in a recommender system; without enough persons being aware of a website, it cannot be linked, regardless of how relevant it may be.

The present invention can address such deficiency in a search context as well, by allowing certain websites, which are likely to be linked to later by a large number of entities because they are trend setters, to be used before such time to render more relevant results. Thus, using the processes noted above, data mining could be performed on entire websites, not just individuals, to determine corresponding website and/or web page trendsetters. In some instances, for example, historical data on the composition and content of websites can be gleaned from online databases, such as the Wayback Machine that is available at archive.org. In other cases a search engine company or trend rater for websites can directly collect content on a regular basis from selected websites in order to rate their trendsetter capabilities. Again, these websites could be identified by topic to search requesters as well as part of a search on a particular search term, so that the latter are made aware of which websites tend to lead the overall Internet in terms of early adoption of material, and thus are likely to have the most “current” information now on subjects, even if they are not the most highly linked to. Thus, in examining hits, the age of a page could be considered as well. The websites could be classified into categories for ease of reference and comprehension.

Thereafter, in response to a particular search query, a search engine could consider the trendsetter rating of a website as part of a weighting algorithm, and the age of a page to present results based in part on the trendsetter status of such website. This additional parameter, therefore, could be used for weighting results, and presenting either a single trendsetter adjusted “hit” list or an additional trendsetter-based results list to supplement a normal search query. The existence and extent of website trendsetters could also be tabulated, compiled and presented for public consumption at search engine websites.

Finally, as noted earlier, the adoption prevalence of certain items (which could be keywords or phrases) can also be studied across a collection of websites to identify the potential for new trends, or the demand for certain items.

In an electronic auction application, such as that maintained by EBay and similar companies, trendsetters are persons who have demonstrated that they can anticipate the expected demand for new types of collectibles that then turn out to be valuable and/or highly in demand. By posting the new activities of such trendsetters (in some cases anonymously, or in aggregate broken down for different types of items) other users can determine what is likely to be a “hot” collectible item in the future, and thus participate at an early stage in the adoption of such items before it becomes too popular, or rises too much in value. The invention is not limited to auctions, of course, and it can be seen that it can easily be extended to other purchasing environments where it is useful to see the behavior of trendsetter buyers/sellers. As noted earlier above, moreover, a prediction can be generated for an auction item, based on demand exhibited by trend setters for such auction item, to determine its potential popularity, and/or to set an initial asking price, to set a reserve price, etc.

Finally, because of the inherent value associated with understanding early adopter behavior, an e-commerce site may charge a subscription fee, or an additional fee, for the privilege of observing such activity. Again, the above are merely examples, and a myriad of other embodiments of the invention will be apparent to those skilled in the art, across a variety of environments which benefit from the identification and use of trendsetters.

Use of Trendsetters for Other Purposes

As alluded to above, in another variant of the invention, the trendsetters can be defined within an electronic community, and yet serve as predictors for events outside of such community—i.e., beyond just the prediction of the likely demand for an item within the community. These events could be associated with sales of products (books, movies, automobiles, recreational equipment, pharmaceuticals, food, content, etc.) or some other article/service. Thus, at step 310 of FIG. 3A the list of popular items may not even be items that are made available to the online community by an e-commerce website operator, but, rather some other item outside the realm of the online community.

For example, in the Mallon et al. application, it is noted that an overall “buzz” for a movie is measured within an online community, and this buzz is used to predict the potential commercial success of such movie in a release to the general public. In a similar fashion, the present invention could be used to measure this same overall “buzz,” but within a more defined, focused and meaningful population sample—namely, identified trendsetters within an online community.

To do this in a movie prediction application, for example, the top 100 current movies (in gross receipts or attendance, or some other measure) is specified at step 310. Then, by performing a similar analysis to that noted earlier, a community website operator could determine the first “adopters” of such movie within an online community. This could be done, for example, by examining the dates/times when members first “adopted” the movie, such as by reading an ad about the movie, discussing the movie, or reading an article about the movie. Other techniques for measuring an “adoption” will be apparent to those skilled in the art.

Thereafter the identified trendsetters and trend predictors could be used to predict the popularity of a new movie. The movie could be “introduced” into the online community in the form of one or more ads presented electronically, one or more stories, one or more excerpts, one or more dedicated newsgroups, etc. By measuring the prevalence of adoptions made by trend predictors, the present invention can thus mimic and yet provide a superior prediction to that described in Mallon et al.

The above is just an example, of course, and other techniques and variants will be useful of course for predicting prospective economic activity for other types of products, services, etc. The invention can clearly be extended to other types of predictions for demands for other products and services.

New items can be introduced to an online community (or other population) through a variety of means, including online advertising, and their adoption prevalence then measured among trendsetters and trend predictors. Furthermore, by comparing the changes in adoption prevalence, an advertising entity can measure an effectiveness of an ad or ad campaign, again, in a manner similar to that done by Yahoo!, but on a more useful subgroup.

In yet another variation involving a recommender system, a user-rating matrix for items could be computed based on identifying ratings supplied by trend setters and trend predictors identified through the present invention. It can be seen that the user-trendsetter rating matrix shown in FIG. 2B has a form similar to that described in the user-item rating matrix in the article by Melville et al. above.

The latter suggests using content filtering to populate such matrix when there are no ratings from a user for a particular item, to solve the so-called sparse matrix and first-rater problem. The Melville authors postulate that if the user-rating matrix is fully populated, this leads to better predictions and recommendations. The pseudo ratings used to fill in the user-rating matrix are thus combined with actual ratings from the user to arrive at a recommendation, using what they call a “content-boosted” collaborative filtering algorithm.

In lieu of the pseudo-ratings for items that are based on the user's own selections, a recommender system in accordance with the present invention can use pseudo-ratings for items which are derived from trendsetter or trend predictor ratings for items, or, at least, for relatively new items. The latter ratings, of course, could be gleaned very easily using a basic averaging calculation across the universe of trendsetters or trend predictors who have actually rated the item. The negative ratings, or rejections made by trend setters could also be incorporated.

In this fashion, a trendsetter “boosted” collaborative filtering system can be implemented, instead of using a pure content boosted approach. Moreover it may be desirable, for example, to still use the content-based pseudo ratings from Melville for those items that are relatively old. Thus, a combination or hybrid approach for generating pseudo ratings for a user-item rating matrix can be effectuated using the present invention.

The benefit of such approach is that it has the effect of associating or causing new users to be associated (or artificially neighbored within the user's cluster in a CF sense) with trend setters or trend predictors. This, in turn, means that new items rated by trend setters or trend predictors will be brought to the “conscious” of the recommender system more rapidly, and thus an overall learning rate for new material should correspondingly improve. Furthermore, since trend setters and trend predictors are drawn from a set of persons who tend to mirror the population's overall behavior at a later time, there is little risk in artificially inducing a learning error. Accordingly, based on conventional metrics for evaluating the performance of a prediction algorithm, the present approach should improve a sensitivity and specificity rating, because the pseudo ratings are based on ratings that are likely to be adopted by the new users based on an analysis of historical data (i.e., the predictive value provided by trend setters).

Other uses for trend setters and trend predictors within a recommender system will be apparent from the above, and the present invention is not limited in this respect.

Because of the natural additional value provided by trendsetters to an e-commerce system, it is desirable to identify such persons at an early stage. Accordingly, one mechanism which could be employed, when demographic and/or preference data is available, is to conduct an initial interview with new users to glean their interests and preferences. By correlating this with profiles of known trendsetters, an e-commerce system can quickly identify such new user as a potential trendsetter. After such label is provided, a new user can be treated in accordance with such status for purposes of advertising, incentives, etc.

For example, within a particular community, trendsetters may be determined to share a common interest in a set of particular items, or they may rate certain specific items highly. During the initial sign up period, a user could be prompted with specific trendsetter signature or fingerprint questions, and the results could be compiled to see if they match a trendsetter profile. In one particular embodiment, a recommender system may “learn” the preferences of a new user by providing them a survey which requests that they rate certain items, such as movies, music, books, etc. As part of such interview/survey, the system may intentionally request specific rankings on items which are rated high (or low) by trendsetters, to see if they are also rated in a corresponding fashion by the new user. This additional trendsetter-related interview can be merged with, or used as a separate supplement to a normal demographics collection interview. Other variations of this interview and trendsetter data collection process will be apparent to those skilled in the art based on the type of system which utilizes trendsetters.

Since the track record of such individual is not sufficiently complete as to determine with certainty whether they are indeed an actual trendsetter, the initial designation may be classified as tentative. The initial rating could then be updated later as the user performs actual adoptions. Consequently, as part of a demographic profile, a user may have a trendsetter identification or status field which includes an adjustable value representing a numerical trendsetter rating, and a separate field which indicates whether such rating is tentative or not.

The above methodology could be applied in a similar fashion to a website, a particular service, etc., by examining whether they meet certain criteria known to exist at other corresponding websites, e-services and the like which are known trendsetters. Again, by identifying signature marks of trendsetter entities, and then comparing them to features found at new entities, a reasonable comparison can be made to arrive at an initial tentative trendsetter designation.

The ratings provided by a tentative trendsetter may be weighted differently by a recommender system, or other system, until such person or entity has established a sufficiently developed track record of adoptions so as to be statistically useful. Again, it is expected that the particular number of adoptions or period for evaluation will be a function of a particular market, product, etc., so it may vary widely across different applications.

Trend Laggards/Rejecters

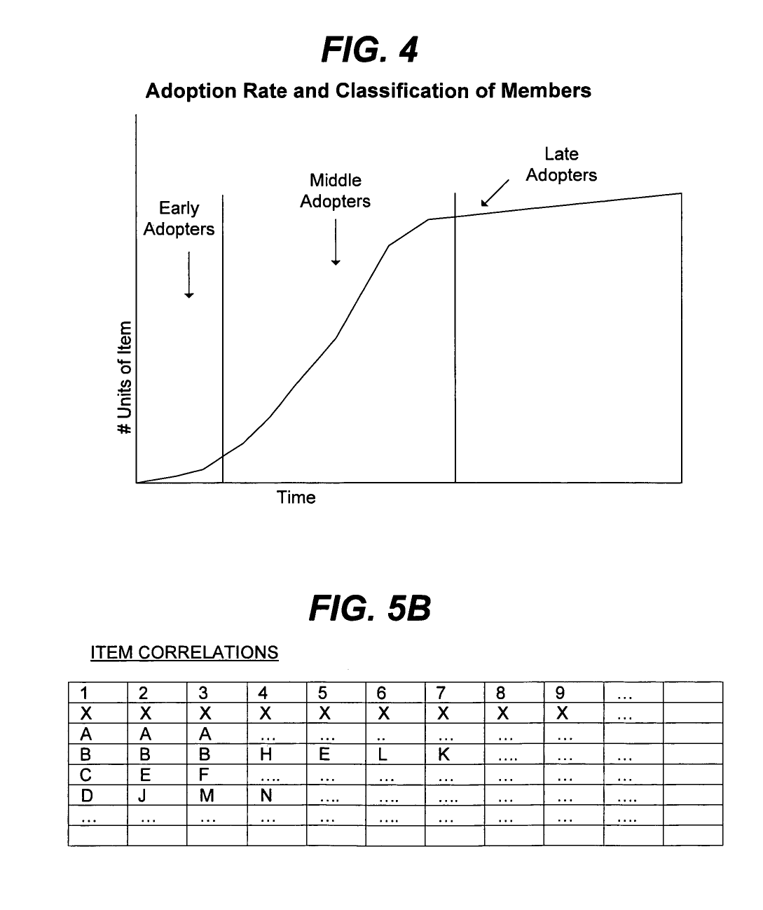

FIG. 4 is a time chart illustrating a typical adoption rate of a new item within an online community, identifying particular regions where subscribers behave as early adopters, middle adopters and late adopters. This last category, which may be described as “trend laggards” may also be useful to identify as well, for a variety of reasons.

First, the prevalence of an item in sufficient quantities within a set of trend laggards may indicate the end of a useful adoption cycle for such item. In other words, the item is likely to not experience further adoption by existing members, and it may not be worth further advertising and/or marketing efforts. Moreover, for the reasons articulated in Garber et al. above, measuring adoption rates by both trendsetters and trend laggards may be useful as a benchmark for identifying products which are likely to fail. That is, if a product achieves a relative substantially uniform adoption rate between both trendsetters and trend laggards at certain initial stages, this can be taken as an early indicator that such product is not likely to achieve a clustering effect which will bring about rapid word of mouth acceptance.

Other uses for the trend laggards will be apparent to those skilled in the art. Again, identifying the trend laggards can be done using techniques similar to those described above for the trend setters.

The selection and manner of advertising might also be differentiated to subscribers, depending on whether they are identified as early, middle, or late adopters of items.

Moreover, in a similar fashion it should be apparent that another class of subscribers, who can generally be described as trend rejecters, can be determined by the present invention. Every community will include some percentage of persons who for some reason or another, have attitudes, tastes, behaviors that run counter to the norm, and it may be useful to identify such persons as well. One manner in which they can be determined is by comparing a set of items that are rejected by the trendsetters, and then evaluating which persons in the community tend to rate the rejected trendsetter items highest.

Thus if trend laggards (and/or trend rejecters) can be identified, their contributions or weightings to a recommender system might be adjusted in a similar manner to that provided for trendsetters, except in the opposite manner. That is, trend laggards (and/or trend rejecter) selections or behaviors might be reduced in weighting within a recommender system, as a way of giving better (or more current) recommendations to the average subscriber.

The present invention, therefore, affords a mechanism for identifying and characterizing members in accordance with their adoption times for certain items. Of course, if it is desirable or interesting to look at adoption time frames other than “early” or “late” this can also be done using the present invention to identify such types of persons. It will be apparent to those skilled in the art that the chart of FIG. 4 is merely an example, and that the actual demand curves for a particular item may vary significantly from that shown without deviating from the teachings of the present invention.

Item Predictors

In another variation of the invention, it is possible, in some instances that certain items can themselves act as a type of trend predictor. For instance in traditional content filtering systems, correlations are often made between items, without regard to their characteristics. An example of this is illustrated in commercial recommender systems used by Amazon and TiVo, which, for instance, will recommend a second item based on the user's selection of a first item, based on the fact that two items are often selected together by other users.

These systems thus work in part by using the correlation between two items using a Bayesian algorithm, such that when a person selects A, the system recommends B as well based on the fact that a large number of persons who have selected A also pick B at some point in time. Thus, these types of correlations also provide a degree of behavioral measurement for an online community.

Another way to look at these kinds of correlations is to notice that certain items, even if they are not necessarily popular community wide, can nonetheless act in some instances as predictors for other related items. Thus, for example, an obscure movie title might be highly correlated to a more popular title within the adoption profiles of a large population base. In this respect, therefore, it can be said that the obscure item acts as a type of signature, marker or predictor of the potential for a more popular item. While a single item by itself may not be sufficiently correlated to suggest all by itself that another item is likely to be popular, it is possible to group a sufficient number of obscure items in a fashion that may provide predictive value.

For example, a certain item A may be present 90% of the time with an item X, and have little correlation to any other item, including any other popular item. Note that X is not necessarily highly correlated to A, however. Another relatively obscure item B may have a similar high correlation to item X. A and B may also be highly correlated to other popular items.

Thus if A and B have a very low prevalence rates and yet they tend to be associated with relatively popular items at a rate much greater than other low prevalence items, they can behave or act as a form of trend predictor by virtue of the fact that they lead to the recommendation and/or adoption of popular items.

Accordingly, within a population of online members, suppose that a new product Y is introduced, and A and B both become rapidly correlated with Y. One type of prediction can be made to suggest that Y is also likely to become a popular item as well, since A and B are relatively good markers for predicting the success of items they are related to.

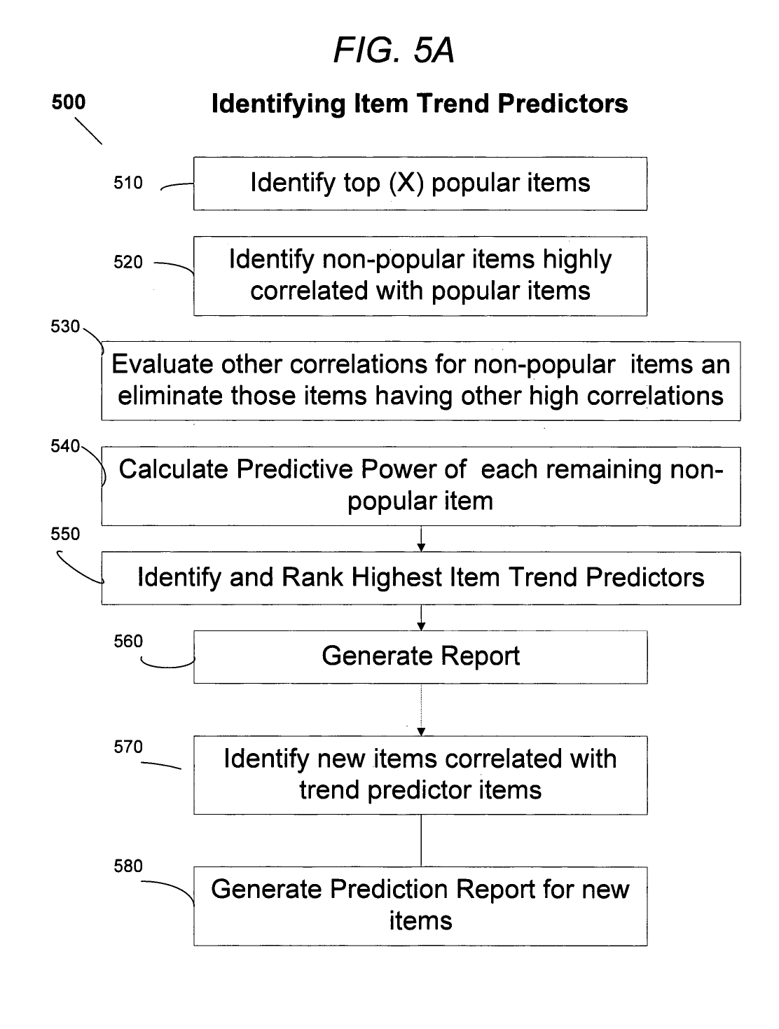

A preferred process for identifying a set of trend predictor “items” therefore is shown in FIGS. 5A and 5B.

In FIG. 5B, a set of items selected by a group of adopters Y1, Y2, . . . etc. is shown. As can be seen there, X is very popular, and both A and B are highly correlated to X, even though the latter enjoys a greater correlation perhaps with other items.

In FIG. 5A, a flowchart is given for the process of identifying trend predictor items. At step 510, a set of popular items is identified, in the same manner as discussed above. At step 520, non-popular items that are highly correlated to popular items are then identified. At step 530, the other correlations of the non-popular items are also examined, to isolate a particular set of items that will serve as useful predictors and markers;—i.e., they are highly correlated to popular items, and not to obscure items.

At step 540, the overall predictive value of the item is calculated, based on examining how many popular items it is associated with, the degree of correlation, and the degree of popularity of the item. Again, the calculation can be based on a matrix type approach as noted above using conventional methods, and normalized as desired to yield a trend predictor value for each of the potential trend setter items.

Thus, at step 550, the set of trend predictor items is created, preferably in an ordered list, so that the top trend predictor items are identified in sequence. A report of the same can be generated at step 560.

The benefit of knowing the set of trend setter items is that they can, of course, be used to some extent to identify trendsetters as well. In cases where an e-commerce operator does not have first hand access to the data selections by particular members, the limited knowledge of the existence of the relatively obscure but meaningful item selections within a user profile can be used to identify trendsetters within another population.

Furthermore, to some extent, the trend predictor items themselves may be useful for conducting another type of item popularity prediction. Thus, at step 570, if items A, B, C are trend predictor items, a search is made for locating new (recent) adoptions in which all (or subsets) of A, B, C are present. Based on these results, a report is generated at step 580 to identify such potentially popular new items.

Again, in some cases it may be desirable to run both types of prediction reports, i.e., based on both trend predictor person ratings, and trend predictor item ratings, to compare the results and see which ones provide more accurate evaluations over time for a particular community. Other variations will be apparent to those skilled in the art.

Other Variations of the Invention

While the preferred embodiment is directed to studies and identifications of trendsetters in online based communities, the present invention is not limited in this respect. A number of other entities and business operations can benefit from the present invention. For example, a service operated by TiVo is known to monitor selections and behavior of its subscribers, by observing their selections as made on a local client device within the subscriber's home. Thus, such service can be used to see which subscribers tend to be good predictors of popular programming, by observing, collecting and tabulating programming selections to identify trendsetters and trend predictors. The trendsetter and trend predictor lists for a content programming service such as TiVo are also valuable commodities which can be sold and exchanged with other commercial entities. It will be apparent to those skilled in the art that the present teachings could be employed in such environments as well, since the data collection for subscribers can be examined in a manner that allows for identification of trendsetters and trend predictors as noted above.

Similarly, a communications service provider (AT&T for example) could use the present invention to observe the behavior of cell phone users, to identify the existence of trendsetters within such population. For instance, such service could monitor which subscribers are the first to use various features offered by the service, such as special calling functions, email functions, etc. This same process could be employed by a number of other consumer and business electronic equipment providers to better glean the demographics, needs and interests of their purchasing base.

In yet another application, the invention could be employed by software vendors to observe and identify purchasers who are trendsetters with respect to the vendors' products. For example, a company such as Microsoft could see which customers are the first to use or exploit new functions and features provided in a commercial software package, or operating system package. A content provider such as Yahoo! could use the invention to monitor which subscribers are the first to look at certain types of contents or online functions that ate made available in new releases.

Structure of the Preferred Embodiment

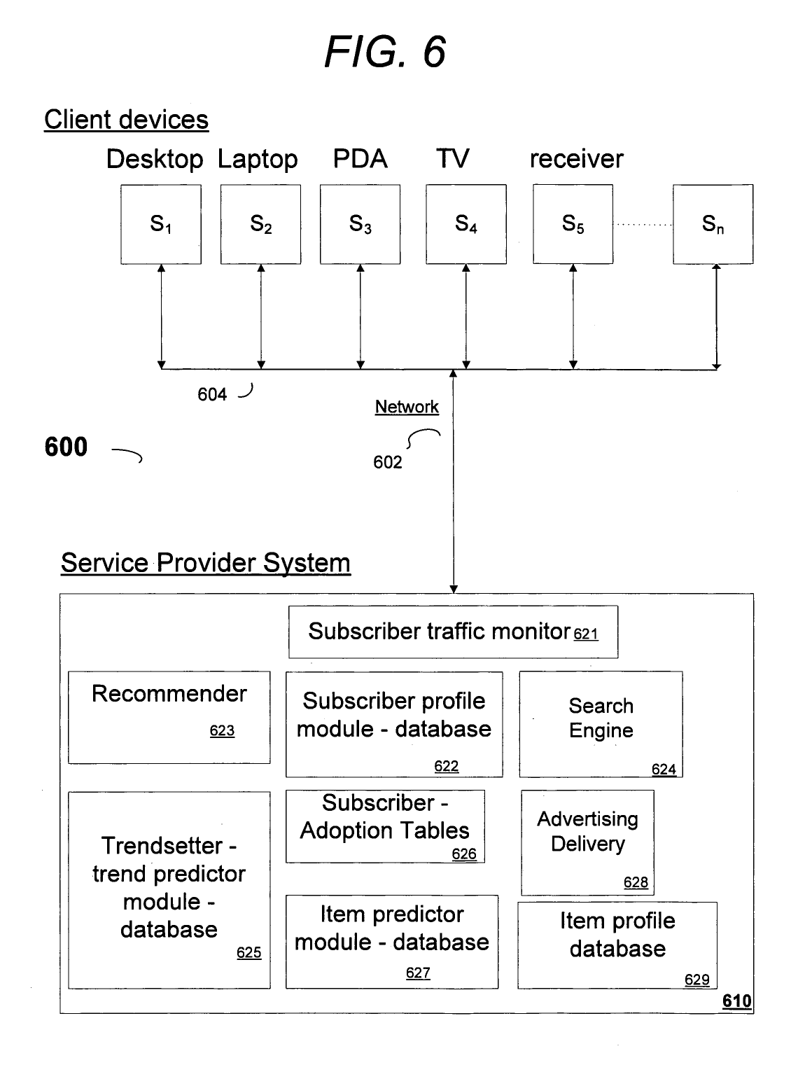

A preferred embodiment of a trendsetter identification and demand prediction system 600 constructed in accordance with the present inventions is illustrated in FIG. 6. The system is composed of several components including a Network 602, through which a number of separate Network Connections 604 are provided to a Service Provider System (preferably a Server Device) 620 by a plurality of Customer Network Devices 612. It will be understood by those skilled in the art that other components may be connected to Network 602, and that not all connections shown need to be active at all times.

There are also several software components and electronic databases associated with the aforementioned network-connected devices, including a Subscriber Traffic module 621, a Subscriber Profile Module/Database 622, a Recommender module 623, a Search Engine module 624, a Trendsetter-Trend predictor database 625, a Subscription Adoption table database 626, an Item predictor database 627, an Advertising Delivery system 628, and an Item profile database 629. Some of these software components of course are essentially the same as those found in a prior art system, except they may be modified appropriately to cooperate with the new software components of the present invention.

Network 602 is preferably the Internet, but could be any implemented in any variety of commonly used architectures, including WAN, LAN, etc. Network Connections 604 are conventional dial-up and/or network connections, such as from analog/digital modems, cable modems, satellite connections, etc., between any conventional network device and an Internet Service Provider in combination with browser software such as Netscape Navigator, Microsoft Internet Explorer or AOL. In a satellite media distribution system implementation, Client Device 612 is a satellite receiver, a TiVo receiver, or the like, and an interface to a service provider does not require a browser.

In most applications, Customer Network Device 612 will be typically desk top computers, laptop computers, personal digital assistants (PDAs), cell phones, or some form of broadcast receiver (cable, satellite, DSL). Server Network Device 610 is typically a network server supporting a service provider website, which, again, may be comprised of a set of logically connected and linked webpages accessible over the Internet. Of course, other structures and architectures may be more suitable on a case by case basis for any particular implementation of the present inventions, and so the present inventions are not limited in this respect.

Software elements of the present invention typically will be custom tailored for a particular application, but preferably will include some common features, including the following.

Operating on System Network Device 610 are the following software routines and/or supporting structures, which implement a form of media distribution.

First, a Subscriber traffic monitor module 621 observes subscriber behavior, including explicit and implicit data input. Thus it logs subscriber activity, such as queries, page views, item adoptions, etc. as noted above.

A Subscriber Profile Module/Database 622 analyzes subscriber inputs, queries, title selections, title deliveries, etc., and forms a customized interest profile for each subscriber. This can be done in using any conventional method. This customized subscriber-specific information is in addition, of course, to any other basic customer-specific information that may be maintained, such as authorized user names, account numbers, physical addresses, credit card information, etc.

Based on such information in a subscriber profile, a Recommender module 623 operates to provide suggestions for items that are likely to be of interest to the subscriber. These can also be provided within a standard query interface presented by a Search Engine module 624. Again, a variety of such types of recommender systems are well-known in the art and can be incorporated within embodiments of the present invention. The item suggestions may be provided while the user is engaged in an interactive session across network 602, or, even while the user is not connected to Service Device 610. The benefit of the latter feature, of course, is that a subscriber delivery queue can be updated even without direct ongoing participation by the user, who may be too busy to engage in a session to locate items. As noted above, Recommender module 623 may generate recommendations that are influenced by the trendsetters and trend predictors in accordance with the discussion above.

A Search Engine module 624 again works in a conventional fashion to retrieve content, materials and results from the service provider site, or other websites, in response to user queries. Profile or cataloguing information for items of interest to the subscribers may be organized in an Item Profile database 629. This item profile information may be searchable by subject matter, category, genre, title, artist and other attributes as determined by subscriber interests, system administrative requirements, the nature of the item in question, etc. Search Engine module 624 also presents a query interface to subscribers to allow them to peruse and view information about the media items. Again, as noted above, Search Engine module 624 may generate results that are influenced by the trendsetters and trend predictors in accordance with the discussion above.

An Advertising delivery module 628 is responsible for delivering advertising to the subscribers, including the trend predictors, in accordance with the techniques described above. Furthermore, as discussed above, Advertising delivery module 624 may also generate advertising that is directly influenced by the trendsetters and trend predictors in accordance with the discussion above.

A trendsetter-trend predictor module 625 basically functions in accordance with the processes described above in connection with FIGS. 1-4. Based on such operation, a trendsetter-trend predictor database is created to include the type of data noted above as well. The trendsetter database is derived, as noted above, from examining Subscriber Adoption Tables 626. This module is also used, as noted earlier, to generate prediction results for demand for new items as may be requested by the service provider, and to identify trend laggards and/or trend rejectors as may be requested.

Finally, an item predictor module/database 627 operates in accordance with the description given above for FIGS. 5A and 5B.

Innovation/Item Dissemination Prediction Based on Measuring Internal Influences

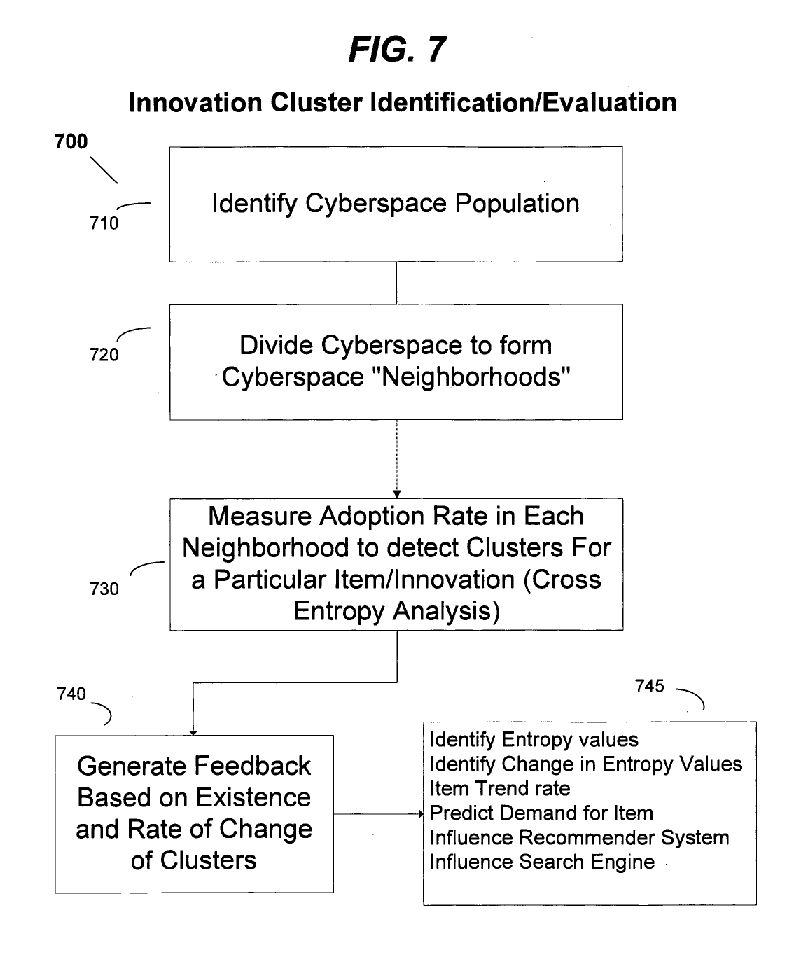

Another embodiment of the invention is illustrated with reference to FIG. 7. The process described there, which is used for locating clusters of high adoption rates in cyberspace defined neighborhoods, can be used to supplement the aforementioned trendsetter identification methodologies.

The cluster identification method of FIG. 7 builds on the models proposed by Garber et al and extends them to logical or cyberspace based neighborhoods which may or may not have common geographical characteristics. In a preferred approach, the individual neighborhoods are individual “Purchase Circles” as defined, compiled and used at a website operated by Amazon.com.

Basically, a “Purchase Circle” is a term used by such e-commerce operator to designate a group of individuals sharing one or more common demographic characteristics, such as a geographic characteristic (country, state, city, etc.), a domain characteristic (AOL, Yahoo!, etc.) a workplace characteristic (a particular governmental agency, private company, etc.) an educational characteristic (university/college of attendance), a hobby characteristic (antiques, coins, gardening, sports, etc.) and/or a professional affiliation characteristic (legal, medical, engineering, etc.). This information is obtained from persons interacting with the website, either explicitly from user provided profiling information, product purchase information, etc., or implicitly such as by monitoring user interaction with such website. The latter includes, for example, analyzing key words, queries, postings, web pages, etc. associated with the user's interaction.

In other instances, a user's Internet Protocol (IP) address can be used as a reasonable proxy for a geographic location designator. For example, one company (Verifia) sells a software package (NetGeo) that includes a mapping of each IP address to specific geographic data. Their product allows a website operator to determine a user's city, state, country, zip code, and other pertinent geographical data simply from an IP address. A similar product is offered by Digital Envoy (NetAcuity) and is suitable for similar purposes. Either product permits easy identification of geographic information associated with a particular online browser, and can be used with embodiments of the present invention.

Thus, in many instances a user's IP address can be used to determine a geographic location, and/or can serve all by itself as a geographic indicator. Further information on a related technique for determining geographical information from an IP address can be found at maxmind.com (add “www” prefix) and in an article entitled “An Investigation of Geographic Mapping Techniques for Internet Hosts” published and presented by Venkata N. Padmanabhan et. al, at SIGCOMM'01, Aug. 27-31, 2001, San Diego, Calif., USA, which is hereby incorporated by reference herein.

In other instances it may be possible to deduce a user's approximate geographic region by measuring a ping time to his/her computer, and then determining a distance with reference to one or more known sites. Thus, by conventional triangulation with reference to multiple sites, a user's location could be localized in some instances to a reasonably small geographic region. See e.g., US application publication no. 2002/0163882 incorporated by reference herein.

Alternatively the geographic data may be read from electronically stored reference data on such computer (such as a license pack, or CPU serial number), or monitoring operating characteristics of such computer, or an authorization card. This would be the case, for example, in the situation of a content provider such as TiVo, where the subscriber's home receiving unit contains identifying information which can be extracted during an update to the subscriber.

Additional details about Purchase Circles can be found at Amazon's website and in WO Patent Application 00/62223, which is based on U.S. Ser. No. 09/377,477, both of which are hereby incorporated by reference as if fully set forth herein. It will be understood by those skilled in the art that the “Purchase Circle” methodology could be applied to aggregate and communitize other groups of individuals based on other shared characteristics (e.g., types of pets owned, real estate owners/renters, automobile preferences, content preferences, etc.) and that the present invention is not limited in this respect.

While in the preferred Purchase Circle context there is at least some element of a common geographic factor, and thus imitation can occur as a result of physical interaction and proximity, the present invention contemplates extending the Garber cluster detection approach to something more than the purely geographical neighborhoods envisioned by the former. This extension is proposed because there is no question but that certain products and services experience far greater initial exposure in cyberspace on the Internet than they do in other forms of media. Moreover, the degree of electronic interaction and fraternization by members of the public on the Internet is increasing rapidly, as measured for example by the number of hours spent online by the populace.

Thus, in an analogous fashion to Garber et al, the inventor submits that there are in fact already “cyberspace neighborhoods” which can be identified (or created) and examined to determine the existence of adoption clusters, much in the same way Garber et al attempts to locate geographical clusters. Such cyberspace neighborhoods also have an analogous word-of-mouth, which in such environments exists as a strong influencer for the adoptions of new products and services. Imitative behavior can thus occur between users who are not necessarily connected geographically, because they share a common online experience including through common website exposures, common webpage views, common search engine utilization, common portals, common click routing, etc.

Consequently, by looking for the genesis, existence and growth of cyberspace adoption clusters, a useful benchmark test can be made to determine the expected popularity, prevalence, commercial success, etc., for a particular innovation. A preferred process for achieving such result is depicted in FIG. 7.

In a first step 710, the cyberspace population which is to serve as the reference market is defined. The scope of this population could range from a large set of entire Internet domains (i.e., Yahoo!, Google, AOL, etc.) to something as small as a single message board devoted to a single topic. The only criterion of course is that the overall sample be sufficiently large so that measuring the various parameters below results in reasonably useful predictive information. This can be determined experimentally by examining historical adoption and prevalence data. Since this will vary on an innovation by innovation basis, it will be understood that the scope of the cyberspace population may be different as well. Again, in a preferred embodiment, the cyberspace population consists of shoppers and purchasers of the Amazon website who form part or all of the Purchase Circle universe.

As with the trendsetter identification process noted earlier it is also the case that the cyberspace population in question may not even be the intended final target market for the product or service in question. In such cases the present invention provides a reasonable proxy for emulating the expected prevalence rate of the innovation across a different population.

At step 720, the cyberspace is divided into a number of “neighborhoods.” Again, as noted earlier, an electronic neighborhood may have little or nothing in common with a geographic neighborhood shared by the members of the cyberspace population. The neighborhoods may consist of individual preexisting domains (for example Yahoo!) or subgroups of such domains (for example communities within Yahoo!). In other instances it may be members who share a similar Internet Protocol (IP) address.

In a preferred approach, the individual neighborhoods consist of a single Purchase Circle, taken from the set of Purchase Circles which have a common geographical characteristic. For example, a Purchase Circle corresponding to the city of San Francisco. Other geographic based groups based on IP address, country, state, domain name, workplace, etc., could be used instead.

A cyberspace Purchase Circle could also be based on a smaller geographic unit, such as a zip code, or a telephone number, including area code and three digit telephone prefix (in the telephone number X-YYYY, XXX can be considered a telephone prefix) when such information is available.

Those skilled in the art will appreciate that the type of Purchase Circle examined may be a function of the type of product/service being examined. That is, in some instances it may be preferable to observe workplace related purchase circles, as opposed to domicile related purchase circles. This would be true, for instance, where the “influence” associated with adopting the item is more closely associated with the workplace, because people come into contact with co-workers on a regular basis. Thus, for items such as high end clothing, it may be desirable to look at workplace purchase circles, and not domicile purchase circles. Other examples will be apparent to those skilled in the art.

Alternatively, cyberspace neighborhoods may be “synthesized” from a variety of unrelated Internet domains. As noted earlier, these types of neighborhoods may or may not have a common geographic factor. Garber et al focus on a geographic factor, based on an assumption that this is a strong indicator of potential intra group individual behavior influence. The basis for this lies in the fact that a common geography also denotes other common factors associated with a population group, such as common work opportunities, common climate, common cultures and customs, common leisure time activities, etc., and, most importantly: common needs. Accordingly, in the study involving air conditioners described in Garber et al., the adoption clustering is based on a common need to respond to a common climatological event, such as hot weather. In a similar vein, a community that lives near an ocean, lake or river can be expected to have a significant number of water sports related items.

When considered in this light, the geographic factor is merely behaving as a loose benchmark common denominator for these other more specific common characteristics and experiences shared by a particular group. For this reason, it is not strictly necessary to use a geographic factor to examine a clustering behavior, and, moreover it may be more preferable to look at a synthesized set of neighborhoods.

Of course, some additional caution and study is necessary when considering how to construct logical or cyberspace “neighborhoods,” since the Internet contains thousands of existing large and small communities which by their nature are more or less focused on particular topics. These communities range in size from entire domains (Yahoo! for example) to particular specialized logical groupings imposed by e-commerce operators (Amazon Purchase Circles for example). So it is important not to create a synthetic neighborhood which is already biased because of an initial population selection.

Members of these communities share common attributes, and may have word of mouth (or word of mouse as it is sometimes referred to) interactions. Nonetheless, it is unlikely that any purely random sampling of such communities would serve as a sufficiently accurate proxy for predicting demand for a particular product.

Accordingly, it is desirable to construct a cyberspace neighborhood in a manner that best reflects actual influences and imitations in the market place in the form of adoption clusterings for different types of products/services. This can be determined by conventional statistical analysis on a product by product (or service) basis, or using other known methods to arrive at a division and classification which is suitable for a class or category of products/services.

For example, a study can be made to determine the genesis and rate of spread of an adoption of a particular product, which may be an item of entertainment content (i.e., a music CD, movie title, book, etc.). An analysis can be made of queries and postings made within different groups at the Yahoo! website to identify the names of groups, the adoption rate by such groups, etc., for such item. Thus, the past distribution and spread of such item can be identified and tracked, so that relationships and influences between groups can be determined as well. By studying a historical behavior of such groups, a correlation can be made to identify some of them as appropriate cyberspace neighborhoods for particular products or services.

This is but an example of course, and other approaches could be used for other type of products and services.

In any event a set of groups and their respective influences on each other can be gleaned through a variety of mathematical techniques known in the art. These relationships in turn can be used to identify “cyberspace neighborhoods” which imitate the effect of geographical neighborhoods in the real world, because they exhibit a similar word of mouth spread of ideas. Thus, by studying the dissemination of an innovation from one set of online users to another set of online users, the existence and extent of an influence exhibited by a particular group can be identified.

For example, it may be determined through such analysis that a first Yahoo! group (i.e., in Gardening) consistently tracks and follows adoptions made by a second group (i.e. in Housekeeping). Of course, the two groups may not even come from the same Internet domain or website, but may be logically connected so that the members of each tend to come into virtual contact by virtue of being exposed to similar Internet landscape. The latter point of course, may result of the fact that they have similar Internet surfing behavior as a result of common interests. The opportunity for imitative behavior is thus high, even if a geographic proximity is lacking. In such instance, the first group can be considered as a form of “cyberspace neighborhood” which influences a second cyberspace neighborhood—namely, the second group. Again, these types of cyberspace neighborhoods may be used in lieu of the preexisting Purchase Circles compiled by Amazon.

Despite the above examples, it will be understood that it is not critical that the members of a neighborhood have any logical or content connection to each other; it is only necessary to identify the existence of particular groupings of online users which, when they are classified into logical neighborhoods, are confirmed experimentally to have predictive power based on an observation of behavior imitation. In this regard the existing logical classifications in which such users are found serve as useful dividing lines, but are not determinative. Thus, it may be determined empirically that certain groups identified under a particular logical classification do not serve any useful predictive function when they are considered as a cyberspace neighborhood.

To remedy the fact that preexisting online user groupings may not serve as useful benchmarks, another alternative that could be used is to synthetically compile a set of cyberspace neighborhoods comprised of members from disparate groups. As an example, a “neighborhood” could be constructed by analyzing message board groups across multiple domains, or multiple “blogs” across Internet space. As blogs continue to proliferate, they may in themselves serve as raw material for compiling cyberspace neighborhoods.

Regardless of how the neighborhoods are determined, at step 730, an adoption rate is measured to detect for kernels and clusters. In a preferred approach, “adoption” in this instance can refer to the type of behavior noted above in the trendsetter analysis; i.e., an evaluation of whether a particular user looked at, purchased, rented, queried, or talked about an item during an electronic data collection session.

Again, in a preferred approach, the Purchase Circles at Amazon associated with a common geographic factor would be examined to determine the distribution of such adoptions of a particular item, such as new book, CD, movie, or any other article of commerce which can be purchased at such site. Preferably, of course, actual purchases are used, since they are the best barometer/indicator for adoption of an item.

In some instances, however, a lower level of endorsement could be used to signify an adoption, such as by making a request or posting about a particular item. In the case of online systems such as Message Board operators, it may be challenging to determine an actual adoption rate, since the number of unique adoptions can be clouded by the fact that individuals can present multiple identifies, post/query in multiple instances, etc. Accordingly, safeguards should be implemented to avoid significant double-counting and other false positive data which can adulterate the adoption rate measurement.

In the preferred embodiment, the analysis of actual purchases by Purchase Circle members is conducted in accordance with the guidelines set out in Garber et al., including an examination of the spatial diffusion of the acceptance rate of the time. This includes a so-called cross-entropy analysis of how much such actual measured diffusion varies from a standard or uniform distribution. If the adoption rate for the item is not uniform, this denotes the existence of kernels (small groups of geographically contiguous individuals) and clusters (a larger group of geographically contiguous individuals), and this in turn suggests favorable adoption behavior, because it indicates the existence of internal influence (as opposed to external marketing factors) driving the adoption. Thus, the existence of kernels and/or clusters in Purchase Circles (or the particular cyber neighborhood under consideration) can be taken as an indication of internal influence and imitative behavior occurring within such groups.

To perform the cross-entropy analysis, the individual users within Purchase Circles are then partitioned into appropriately sized windows, and examined using the stochastic cellular automata model described in Garber et al. The window size is preferably a uniform sized so called “Parzen window,” as discussed in Garber et al. but may still yield valuable data even if it is based on existing non-uniform data sets, such as a particular IP addresses, cities, zip codes, domains, etc. associated with individuals, or some other measure which can be used as a proxy to designate a roughly equivalent sized contiguous subgroup within a population. The individual Purchase Circles may also be used if they are relatively similar in size.

At step 740 a determination is made of the existence and size of the kernels and clusters of adoptions within the Purchase Circles. If such clusters are determined to exist, by measuring a cross entropy value to see if it exceeds a predetermined threshold value, a prediction can be made as to the probable success of an time early on in the introduction cycle. While the Garber et al technique is preferred in the present method, other techniques known in the art could be used as well to detect the existence of kernels and clusters, and thus the existence of imitation and word of mouth (internal influence) mechanisms affecting an item's adoption rate.

Furthermore, in addition to the absolute measurement of clusters, by measuring the relative growth in time (say week to week), and change in entropy, this can further help to identify a potentially successful item, as noted in Garber et al. In other words, a successful item is typically characterized by a cross entropy value which is very high early on, and decreases rapidly. In contrast, unsuccessful items tend to have cross entropy values which are initially very low and rapidly reach a constant value. For this reason, measuring a change in entropy with time can also serve as a useful benchmark in predicting the potential success of a particular innovation.

As noted in Garber et al, the cross-entropy analysis works best early on in the adoption cycle of an item, since that is when the existence of kernels or clusters is most easily measured. For successful products, there are typically small kernels which grow into clusters. After the product has achieved a certain measure of market penetration, is difficult to distinguish between items which are likely to succeed, or not likely to succeed, because they are both more uniformly distributed.

Garber et al further does not take into account that there may be identifiable trendsetters (as described above) within such clusters, and that by measuring their adoption rate, the probable success or failure of a product/service can be measured at an even earlier date. For this reason, the cluster identification process of FIG. 7 can also serve as an adjunct tool to be used in combination with the trendsetter identification processes described earlier.

Stated another way, a process may be employed which looks only at cyberspace neighborhoods which are already known as trendsetters or early adopters for a particular class of product/service. By then looking for the existence of clusters within such trendsetter type cyberspace neighborhoods, an even more accurate and perhaps earlier prediction can be made for a particular innovation. Alternatively, if a set of trendsetters or tend predictors are already known within a particular neighborhood, a measurement of their adoption rate could be measured instead.

Garber et al also note that in the end of the process, there tends to be clusters of so-called non-adopters, and thus the cross entropy difference becomes large again. Again, this type of analysis could be combined with the trend laggard methodology noted above, to determine an acceptance rate in such population. Furthermore, a continuing lack of adoption among identified trend laggards (or a relative rate of adoption to trendsetters or trend predictors) may serve as a more useful early indicator of a product's demand cycle.

At step 745, an overall report/prediction can be made to indicate the cross entropy value, the change in cross entropy value from a prior measurement date, a prediction for the item's success, etc. The data can also be used, as suggested earlier, to influence a position on a search engine result, or a recommender system. More conventionally of course, in an e-commerce retail environment, such as Amazon where content is sold, a decision can be made to increase or reduce inventory/purchases of an item based on an expected sales of such item, and/or to alter an advertising effort, a recommendation engine score, an item placement within the website, etc. Other similar types of well-known marketing and sales decisions can be based on the item prediction.

In another variant of the invention, a second cross-entropy analysis could be completed at a later time as shown in step 750. In this approach, assuming the date of adoptions for each user is known and maintained, an analysis can be done using a sliding window to determine the existence of only new kernels and clusters since a particular time, which may be at the end of a prior cross-entropy analysis cycle. The same technique could be used, of course, within any bounded time period for the detection of kernels and clusters only within such time window.

To remove the influence of earlier adopters, such members could be excluded from the population. This may require adjusting the Parzen window, as well. As long as the window size is adjusted appropriately for each iteration, an accurate measurement should be possible. In any event the techniques for re-measuring the cross entropy analysis to identify only new imitation kernels and clusterings will be apparent to those skilled in the art from the present description.

This approach would further have the advantage of defeating some of the normal distribution “look” effects which Garber et al acknowledges as a weakness in the model later in the innovation acceptance cycle, because at some point the clusters become so large that they are no longer distinguishable. The present invention proposes, in fact, to continually adjust the model so that the earlier adoptions are filtered, and thus new clusters can be observed. By only looking at new adoptions, or adoptions which only occur within a particular window, a continuous series of cross entropy analyses can be done to detect kernels and clusters on an ongoing basis. In this way the effects of other mechanisms (such as external advertising) can be selectively filtered as well.

Moreover, as alluded above, the entropy value could be computed and compared on a day to day, week to week, or other periodic basis using this method (i.e., looking at a predetermined or fixed period) to see if there are changes in the entropy value with time. Thus, an entropy value for the first 10 days of an item could be compared with the entropy value for second ten days (10-20) of an item by only looking at new adoptions within a remaining population. In the context of analyzing Internet groups for an awareness factor (discussed in more detail below) the user adoptions reflected in page views, queries, postings, etc., can be date/time stamped so that a proper inventory of adoptions is measured for a particular time window. Other examples will be apparent to those skilled in the art.

From a theoretical standpoint, a sliding time window entropy value for a successful product (i.e., for a particular fixed window of time starting from an introduction period) should start off at a first level (signifying adoption by a first subset of the population) and then rise to some maximum as the imitation effects also increase, and then it should decrease again. In other words, with more existing adopters, the rate of imitation should also increase as those persons who are subject to word of mouth influence also adopt in clusters around the existing adopters. At some point a large number of adoptees will be reached, and they will have fewer and fewer members in the population to influence. Stated another way, as the number of potential imitators goes down, the cross entropy value should also go down. Again, using the above techniques, the change in cross entropy value can be monitored to see when the peak imitation rate is achieved, and to help characterize the life span and adoption cycle of a particular item or items.

The results of the present methods could be applied to a number of domains. For example, in an online movie rental environment, such as operated by Netflix at an e-commerce site, an analysis by geographic region of subscribers' rental behavior could be made to determine demand for new movie titles. This can be observed by noting, for example, which movies they select and place in a queue for future delivery. By studying titles identified in subscriber queues, and similar wish lists which identify subscriber interest in yet-to-be released titles, an online rental provider can more accurately determine at a very early stage a potential demand for a particular title. This can occur, for example, most beneficially for titles which have not yet been released, but which for customers can express an interest. In this instance, since Netflix knows the exact address of each subscriber (for delivery purposes) it is relatively easy to perform the type of cross entropy analysis identified in Garber et al. Since predicting demand for a title is critical for capacity planning purposes, the present invention could be used at an early stage to advantage by such types of e-commerce content rental providers as well.

In other instances it may be desirable to do a comparison of cross entropy values between different Purchase Circles, to identify two separate influence mechanisms in two different geographic regions (for instance, a San Francisco Purchase Circle and a San Jose Purchase Circle), or to study a cross-influence mechanism between such Purchase Circles. By studying a change in such values, an e-commerce operator can determine, for example, if certain geographic regions tend to lead or lag other geographic regions. This can be used, in turn, to map Purchase Group influences, and to identify certain Purchase Groups as trendsetters, or trend predictors as noted above. A cross entropy value differential between two adjacent geographic regions might also be used to evaluate a large scale “influence” mechanism operating between such regions.

Again, it should be noted that the aforementioned approach differs from the “buzz” measurements described in Mallon et al, because the latter looks at an aggregate activity across one more groups/domains, and not to the existence and formation of cyberspace kernels or “clusters” of adoptees. In other words, it has the same limitation of the prior art models described in Garber et al. which do not differentiate geographically to see if some localized areas are experiencing rapid word-of-mouth while others are experiencing none. The applicant submits that the detection of formation of cyberspace kernels and clusters of adoptees can also serve as a useful benchmark to predict the probability of success of a particular product or service.

Consequently, the present methods could be used within the context proposed by Mallon et al, i.e., within particular user groups (newsgroups, Yahoo! communities, Yahoo! message boards, or Yahoo! search queries, etc.) to measure the distribution of awareness (buzz) for a particular item—such as a particular movie title, a brand name, a celebrity name, etc.—again to see how it deviates from an expected normal distribution using a cross entropy analysis. Thus, by looking for kernels and clusters of awareness within such online groups, the techniques of Mallon can be extended so that, instead of merely measuring an overall awareness within a general population, a more accurate indicator of the potential success (or predicted economic activity as defined in Mallon et al) of an item can be gleaned. This is done by analogously measuring internal influences between actual neighbors and/or cybernet neighbors.

As a specific example, the so-called “Buzz” Index looks at a number of persons making queries to a particular topic on a given day, and/or examining web pages, news stories, etc. which discuss such topic. It then divides this number by the total number of persons visiting the site, and adjusts the ratio by a normalization factor.

The present invention can be piggybacked on to this existing analysis, to conduct an additional analysis designed to look for internal influences between the individual users providing the queries who share a common geographic factor. Thus, a cross-entropy analysis can be used to see if the awareness for an item is in the form of a normal distribution, or in the form of identifiable clusters.

The benefit of the present invention, again, is that the effects of advertising (which generally result in normal distributions) can be essentially filtered out to see effectively what the real appeal is for a particular item. In the technique described by Mallon et al, a strong advertising campaign can distort the results of the analysis early on, to skew the awareness factor and give a misleading impression of the overall potential of an item.

Again, a geographic common denominator is desired for the reasons set out above. As noted above, in many instances geographic parameters can be gleaned from users either from direct demographics and profile information explicitly provided, or from secondary indirect data such as domain names, client Internet Protocol (IP) addresses, or other affiliations identified by the user. Accordingly, the users making queries can be geographically divided and classified, and studied with the method noted above to see if there are indeed kernels and/or clusters of awareness existing or forming for a particular topic, be it a person, brand name, product, technology, media item, or some other concept.

Nonetheless, as also alluded to above, it is possible that a rigorous analysis of item awareness may reveal that a reasonable proxy for geographic proximity can be had by simply using already existing and defined online groups and subgroups. This is because, as noted above, such groups tend to have common interests, and as the users tend to also interact online by postings, chat and through instant messaging, there is already a significant potential for word of mouth and imitation behavior and effects. Thus, it may not be necessary to specifically extract geographic information, if a reasonable parallel can be established by reference to one or more specific groups within a particular community. These groups then can then be studied as described above to detect for kernels and clusters.

In another variant, particular types of advertising can then be presented to online users, and then a comparison can be made to see if such leads to kernels and clusters (i.e., evidence of word of mouth) or if it merely results in a greater overall awareness in the form of a greater normal distribution. This aspect of the invention therefore allows for fine tuning of advertising techniques within different population groups to ascertain particular presentation content/format which is most effective in creating a word of mouth effect.

In yet another embodiment, the invention could be used to monitor viewing behavior of subscribers to satellite/cable content, and to determine if particular programs are achieving word of mouth popularity. In most instances, a log can be kept of each program watched by a particular user, which can be downloaded and analyzed. These techniques are already well-known in the art, and are not described at length herein.

Nonetheless, to date such systems do not incorporate the kind of analysis noted above, whereby a program's popularity (or adoption as measured by actual viewing, or selection for recording) is measured with reference to the existence of localize pockets or clusters. Again, therefore, such systems may benefit from a cross entropy analysis which identifies kernels and clusters of viewing/selection within particular geographic regions, as opposed to randomly distributed viewing across such universe of subscribers.

Another area where the invention could find utility is in so-called search engine page ranking algorithms. These algorithms are used by Google, for example, to rate the relevance of web pages to particular search queries. The gist of such algorithms is that they look at more than just the content of a webpage to determine its potential relevance to a search query; in fact, a measurement is made of the amount of cross-linking to and from such webpage to other webpages. A detailed discussion of such techniques is presented in L Page, S. Brin, R. Motwani, and T. Winograd, The PageRank citation ranking: Bringing order to the web, Stanford Digital Libraries Working Paper, 1998 incorporated by reference herein.

One potential use of the invention in such contexts, for example, is in helping to root out or eliminate “noise” caused by excessive cross-linking in small clusters of websites. In other words, the Google algorithm relies on cross-linking as a measure of relevance; some sites, however (notably, Blogs) engage in a degree of cross-linking that is excessive and out of proportion to their significance to third parties. By using the present invention, a search engine operator can analyze groups of sites to determine—analogously—if there are discernible clusters/kernels of “adoptions” in the form of cross-links. In other words, in the search engine environment, a cross-link to another page can be considered as an adoption of such page within the framework above. To maintain a more accurate database of reliable websites on which to measure cross-linking relevance, a search engine operator may thus execute the process above to identify groups of websites which exhibit excessive cross-linking. Particular websites could then be removed from an indexing operation to reduce their interference/noise contribution to the cross-linking measurements used to derive a page rank.

The websites and webpages could be determined/tested on a domain by domain basis, randomly, or by another other convenient partitioning scheme which can be processed efficiently. The cyber neighborhoods could consist of smaller sub-groupings of individual pages within a site or domain.

From a relevance perspective—as concerns a page ranking trustworthiness at least—it may be desirable to only include a universe of websites which tend to exhibit a small degree of entropy. Stated another way, the desired metric here may be to intentionally cause a lack of clustering, because the latter may be indicative of a more reliable general dissemination/reliability of a website. As an example, if a webpage has 50 cross links, it is probably more reliable for such links to come from 50 separate reliable webpages derived from multiple websites and/or multiple domains, rather than for such cross links to be in the form of 10 cross links each from only 5 separate webpages originating from a common website and/or single domain. The former measurement would suggest a more uniform adoption of the webpage across a wider universe of persons, as opposed to an artificial/inflated set of links caused by a small group of (potentially biased or interested) persons.

The number of commercial entities attempting to bias and alter webpage rankings is increasing, because securing a higher placement on a search engine “hit” is more advantageous to e-commerce operators. Such sites, and similar sites, do not present quality information from a search perspective, and, in reality, add biased noise using the techniques noted above to artificially inflate certain pages. This in turn can cause a number of false hits to spam sites from an online user's perspective, and cause a reduction in confidence and use of a search engine provider's search utility. In some instances, so-called “link farms” are set up with the sole purpose of improperly enhancing a webpage's rank through artificial links. Thus the present invention can help to identify such entities, remove their influence from a webpage relevance measurement process, and enhance the reputation of a search engine tool.

Accordingly in this instance the invention can be used in a complementary fashion to that described above, with the objective of intentionally determining a set of webpages which are not significantly clustered from a cross-link perspective. In this manner, a filtering can be done of highly-cross linked pages which may contaminate or bias a search result. This process could be combined, again, with the trendsetter process noted earlier so that the status of a website as a trendsetter could be factored into the page rank inclusion process. In some cases, because of their predictive utility, so-called “trendsetter” sites might be used for page ranking activities even if they are highly clustered.

It will be apparent to those skilled in the art that what is set forth herein is not the entire set of software modules that can be used, or an exhaustive list of all operations executed by such modules. It is expected, in fact, that other features will be added by system operators in accordance with customer preferences and/or system performance requirements.

Furthermore it will be apparent to those skilled in the art that a service provider system implementing the present invention may not include all of the modules/databases as noted above, depending on the needs, requirements or desires of its subscribers, and other technical limitations. For example, many websites do not require a recommender system, because they do not provide such functionality to their subscribers. Thus, the invention is not limited to the preferred embodiments noted above. Finally, while not explicitly shown or described herein, the details of the various software routines, executable code, etc., required to effectuate the functionality discussed above in such modules are not material to the present invention, and may be implemented in any number of ways known to those skilled in the art based on the present description.

It will be understood by those skilled in the art that the above is merely an example of a trendsetter identification and tabulation system/method and that countless variations on the above can be implemented in accordance with the present teachings. A number of other conventional steps that would be included in a commercial application have been omitted, as well, to better emphasize the present teachings.

The above descriptions are intended as merely illustrative embodiments of the proposed inventions. It is understood that the protection afforded the present invention also comprehends and extends to embodiments different from those above, but which fall within the scope of the present claims.

What is claimed is:

1. A method of analyzing advertising effect across a number of Internet sites comprising:
(a) dividing a set of webpages into a plurality of measurement windows consisting of a plurality of separate web pages;
(b) measuring an adoption value for an item between said plurality of separate webpages for at least one measurement window;
wherein information for said item has been provided to at least some online users in connection with online advertising presented with said set of webpages;
(c) comparing the adoption value in said at least one measurement window for said plurality of separate webpages with a nominal adoption value using a cross-entropy analysis;
(d) determining whether clusters of adoption exist in each said measurement window based at least in part on the results of step (c).

2. The method of claim 1 wherein said measurement windows correspond to web pages from a common geographic region.

3. The method of claim 1 wherein said measurement windows correspond to web pages from a common online website and/or domain.

4. The method of claim 1 wherein said measurement windows correspond to web pages presented to a single logical subgroup of users of an online site.

5. The method of claim 4, wherein said single logical subgroup consists of message postings for a topic on an online message board.

6. The method of claim 4, wherein said single logical subgroup of users of an online site correspond to members of a cyberspace based purchase circle sharing a common geographic characteristic.

7. The method of claim 1 wherein said measurement windows are synthesized at least in part from a plurality of separate web pages from multiple websites and/or domains.

8. The method of claim 1 wherein said measurement windows are determined at least in part by identifying trendsetter web pages and/or trendsetter websites.

9. The method of claim 1 wherein said measurement windows are determined at least in part by evaluating one or more web logs (blogs).

10. The method of claim 1, further including a step: measuring a change in adoption value in time.

11. The method of claim 1, further including a step: adjusting online advertising to at least some online users based on said adoption value.

12. The method of claim 1, further including a step: adjusting online advertising to different measurement windows of web pages based on measuring adoption rates within said respective measurement windows.

13. The method of claim 1, further including a step: computing an expected economic activity and/or likelihood of commercial success of said item based at least in part on said adoption value.

14. A method of monitoring effects of advertising on Internet web pages including the steps:
(a) providing online advertising for an item in association with presenting one or more web pages at a website to a first set of users;
(b) dividing said first set of users into separate logical groups;
(c) measuring a rate of adoption of said item in said separate logical groups using at least in part an entropy analysis to identify kernels and/or clusters within said first set of users.

15. The method of claim 14 wherein said rate of adoption of said item in said separate logical groups is measured by reference to web pages associated with said first set of users.

16. The method of claim 15, wherein said web pages associated with said first set of users include at least some web logs.

17. The method of claim 15, wherein said web pages associated with said first set of users include at least some message groups.

18. The method of claim 15, wherein said web pages associated with said first set of users include at least some subscriber content queues maintained by users of a content purchase and/or rental website.

19. The method of claim 14, wherein said first set of users include members of a cyberspace purchase circle comprised of individuals sharing at least some common geographic demographic data.

20. The method of claim 14, wherein said first set of users include members of a cyberspace purchase circle comprised of individuals sharing at least one of a common Internet domain characteristic, a common workplace characteristic, a common educational characteristic, and/or a common personal interest characteristic.

21. The method of claim 14, wherein said separate logical groups are classified at least in part by geographic characteristics obtained from explicit user profiles or implicit demographics information derived from user interactions.

22. The method of claim 14, further including a step: predicting further demand for said item or related items based on step (c).

23. A method of providing advertising to online community population the method comprising the steps of:
(a) dividing the online community population into a plurality of measurement windows, which measurement windows include monitored members of the online community distributed across a plurality of subgroups logically associated with an Internet website;
(b) providing advertising for an item to said online community population including to said plurality of subgroups;
(c) measuring a first acceptance distribution for the item across the monitored members by identifying members within the plurality of measurement windows who have expressed an interest in the item;
(d) comparing the first acceptance distribution with a normal acceptance distribution using a cross-entropy analysis;
(e) determining whether kernels of acceptance for the item have formed in the online community population.

24. The method of claim 23, further including a step: performing the operation of step (c) before step (b), and repeating steps (d) and (e) to determine an effect of said advertising.

25. The method of claim 24, wherein a measurement is made to determine if said advertising is causing imitation between members of said online community population.

26. The method of claim 23, further including a step: correlating characteristics of said item to said online community population to determine said measurement windows.

27. The method of claim 23 further including a step: limiting said plurality of measurement windows to individuals who are determined to be trendsetters.

28. The method of claim 23 further including a step: measuring an influence of item adoptions made by a first group of persons within a first measurement window on item adoptions made by a second group of persons within a second measurement window.

29. The method of claim 23 further including a step: limiting said plurality of measurement windows to individuals who are determined to not be trend laggards.

30. A system for providing online Internet related advertising including:
an Internet accessible web server, which web server is configured with one or more software routines adapted to perform the following operations:
(a) measuring a first rate of item adoption within a group of users;
(b) identifying adoption clusters and/or kernels in said group of users least in part based on an evaluation that said first rate of item adoption exceeds a threshold value.
